(19) United States
(12) Patent Application Publication
(10) Pub. No.: US 2024/0392152 A1
(43) Pub. Date: Nov. 28, 2024

(54) WATER-ONLY COLORANT COMPOSITIONS

(71) Applicant: SWIMC LLC, Cleveland, OH (US)

(72) Inventors: Jacob S. DONLON, Chesterton, IN (US); Patricia L. OLOFSSON-ELKOW, Frankfort, IL (US)

(21) Appl. No.: 18/793,139

(22) Filed: Aug. 2, 2024

Related U.S. Application Data
(63) Continuation of application No. PCT/US2023/062086, filed on Feb. 7, 2023.
(60) Provisional application No. 63/307,190, filed on Feb. 7, 2022.

(51) Int. Cl. C09D 17/00

(52) U.S. Cl. CPC C09D 17/001

(57) ABSTRACT

A point-of-sale custom color system for tinting water-borne architectural base paints and stains includes an array of at least white, green, blue and red low volatile organic compound water-only liquid colorants each containing an at least three-component surfactant package; pigment; and a vehicle. The surfactant package compatibly and homogeneously disperses the colorants throughout water-borne base paints and stains but will not compatibly and homogeneously disperse the colorants throughout solvent-borne base paints and stains unless the colorant is used in combination with a synergist containing one or more ingredients that will disperse the water-only colorants into solvent-borne base paints or stains.

### FIELD

This invention relates to colorants for point-of-sale customized-color architectural paint and stain tinting systems, such as those used in retail paint stores to make custom-tinted paints or stains, as well as methods and surfactant packages related thereto.

### BACKGROUND

Architectural paint and stain manufacturers typically distribute premixed paints and stains in a small number of popular colors. To accommodate consumer desires and enable matching of existing painted or stained surfaces, manufacturers typically also distribute a set of tintable base paints or stains and several liquid colorants. These are combined at point-of-sale outlets using volumetric colorant dispensing equipment and shaker mixing equipment to make small batch lots of custom-tinted paint or stain in a much larger array of colors than the limited color array available in premixed products.

Owing in part to industry custom and the available colorant dispensing equipment, the custom color systems from different paint or stain manufacturers tend to have somewhat similar components. For example, a typical custom color paint system may employ several (e.g., 2 to 4) tintable base paints ranging for example from a bright white base that already contains a white pigment such as titanium dioxide and is intended to accept a relatively small quantity of added colorant at the point-of-sale, to a relatively unpigmented clear base that is intended to accept a much larger quantity of added colorant at the point-of-sale. Base paints and stains may employ various binders (e.g., natural or synthetic resins), binder forms (e.g., solution polymers or latex polymers) and vehicles (e.g., solvent-borne or water-borne versions), and may provide various dried surface finishes (e.g., matte, semi-gloss or gloss finishes). Some manufacturers also sell colored base paints (e.g. a red, a blue and yellow colored base) which are intended to be combined with additional colorant(s) at the point-of-sale when strongly-tinted custom paint shades with one coat hiding power are desired. The colorants in custom color paint or stain systems may for example be volumetrically metered from a multiple-colorant dispensing station, with 12 to 20 paint or stain colorants typically being employed in colorant dispensing stations for the U.S. market, and more (e.g., 16 or 24 colorants) sometimes being employed in other markets.

Years ago, paints and stains were virtually all solvent-borne. Although solvent-borne paints and stains continue to be used, nowadays 80% or more of architectural paints and a significant proportion of stains are water-borne. The overall percentage of water-borne paints and stains as a proportion of total sales is expected to continue to increase. Despite that, some workers or customers continue to prefer solvent-borne paints (for example, alkyd paints) or solvent-borne stains in some end-use applications, and may do so well into the future.

Universal colorants have been developed for use in point-of-sale tinting equipment. Universal colorants typically are formulated by modifying a water-borne colorant formulation to include appropriate surfactants, and optionally to include appropriate dispersing agents or cosolvents, so that the colorant can tint either a water-borne or solvent-borne base paint or stain using the same tinting machine. Unfortunately, use of universal colorants requires compromises in paint performance in order effectively to bridge the colorant compatibility gap between water-borne and solvent-borne systems. For example, in water-borne paints tinted with universal colorants, the compromised performance factors may include one or more of higher volatile organic compound (VOC) content, surfactant leaching, increased tack, reduced hardness, reduced blocking resistance and viscosity drop. For solvent-borne paints tinted with such universal colorants, the compromised performance factors may include one or more of longer drying times, reduced film hardness or altered gloss. Some point-of-sale paint stores use water-borne colorants to tint water-borne paints and stains, and employ a separate tinting machine containing solvent-borne colorants optimized for use with solvent-borne paints and stains. However, this solution is not ideal because it requires investment in and maintenance of two separate tinting machines; requires the sale, storage and inventory of extra Stock Keeping Units (SKUs) representing the solvent-borne paint colorants; and may result in colorant shelf life expiration or dispenser plugging problems for less frequently used water-borne or solvent-borne colorants.

U.S. Pat. Nos. 10,933,389 B2 (Ellsworth et al. ‘389) and 10,934,151 B2 (Ellsworth et al. ‘151) describe tinting systems that employ water-only colorants to tint water-borne paints and stains, and employ water-only colorants together with a synergist to tint solvent-borne paints and stains. International Application Publication No. WO 2022/011012 A1 (Donlon et al.) describes tinting systems that employ water-only colorants to tint water-borne paints and stains, and employ water-only colorants together with a synergist and siccative to tint solvent-borne paints and stains.

### SUMMARY OF THE INVENTION

Although the above-mentioned synergist can be used with a variety of water-only colorants to tint solvent-borne paints and stains, improved performance may be obtained by recognizing that optimization of the synergist may not be all that is needed. We have obtained additional performance improvements by optimizing water-only colorants that can be used to tint solvent-based paints or stains with a synergist so that when the synergist is not employed, the colorants will work better to tint water-borne paints and stains. We have developed three (or more)-component surfactant packages for use in making water-only colorants, and an array of water-only colorants containing the disclosed surfactant packages. In comparison to universal colorants, water-only colorants containing the disclosed surfactant packages may provide equal or better compatibility, and better resistance to tinted paint viscosity drop, when used to tint water-borne base paints and stains. The disclosed water-only colorants do not however provide a universal colorant array, as at least the white, green, blue and red water-only colorants containing the disclosed surfactant packages do not compatibly tint solvent-borne base paints and stains unless a synergist that provides the missing compatibility is also employed.

The present disclosure thus provides, in one aspect, a point-of-sale custom color system for tinting water-borne architectural base paints and stains, the system comprising an array of low volatile organic compound water-only liquid colorants including at least white, green, blue and red colorants each comprising an at least three-component surfactant package that will compatibly and homogeneously disperse the colorant throughout water-borne base paints and stains but will not compatibly and homogeneously disperse the colorant throughout a solvent-borne base paint or stain unless the colorant is used in combination with a synergist containing one or more ingredients that will disperse the water-only colorants into the solvent-borne base paint or stain; pigment (viz., a colored, dispersible solid particulate material, or a colored dispersible or soluble dye material); and a vehicle.

The present disclosure provides, in another aspect, a method for point-of-sale custom paint or stain tinting, the method comprising using an automated or manual colorant dispenser to dispense into a water-borne base paint or stain at a retail, wholesale or combined retail/wholesale outlet one or more water-only liquid colorants selected from an array of colorants including at least white, green, blue and red colorants each comprising an at least three-component surfactant package that will compatibly and homogeneously disperse the colorant throughout a water-borne base paint or stain but will not compatibly and homogeneously disperse the colorant throughout a solvent-borne base paint or stain unless the colorant is used in combination with a synergist containing one or more ingredients that will disperse the water-only colorant into the solvent-borne base paint or stain; pigment; and a vehicle.

In other embodiments, the present disclosure provides a point-of-sale custom color system for tinting water-borne architectural base paints and stains, the system comprising an array of low volatile organic compound water-only liquid colorants including at least white, green, blue and red colorants each comprising an at least three-component surfactant package that will compatibly and homogeneously disperse the colorant throughout a water-borne base paint or stain and will compatibly and homogeneously disperse the colorant throughout a solvent-borne base paint or stain if the colorant is used in combination with a synergist containing one or more ingredients that will disperse the water-only colorants into solvent-borne base paints or stains; pigment; and a vehicle.

In other embodiments, the present disclosure provides a method for point-of-sale custom paint or stain tinting, the method comprising using an automated or manual colorant dispenser to dispense into water-borne base paints or stains at a retail, wholesale or combined retail/wholesale outlet one or more water-only liquid colorants selected from an array of colorants including at least white, green, blue and red colorants each including an at least three-component surfactant package that will compatibly and homogeneously disperse the colorant throughout water-borne base paints and stains and will compatibly and homogeneously disperse the colorant throughout solvent-borne base paints and stains if the colorant is used in combination with a synergist containing one or more ingredients that will disperse the water-only colorants into solvent-borne base paints or stains; pigment; and a vehicle.

In additional embodiments, the method further comprises:
dispensing one or more water-only colorants into a water-borne paint and stain to tint a
   water-borne paint or stain; or
to tint a solvent-borne base paint or stain,
   a) dispensing one or more water-only colorants as well as a synergist into a solvent-borne base paint or stain, or
   b) dispensing one or more water-only colorants into a solvent-borne base paint or stain containing the synergist,
The present disclosure provides, in yet another aspect, a packaged colorant comprising a low volatile organic compound water-only liquid colorant comprising an at least three-component surfactant package that will compatibly and homogeneously disperse the colorant throughout water-borne base paints and stains but will not compatibly and homogeneously disperse the colorant throughout solvent-borne base paints and stains unless the colorant is used in combination with a synergist containing one or more ingredients that will disperse the water-only colorant into solvent-borne base paints or stains; pigment; and a vehicle, packaged in a container having a volume of about 0.5 to about 5 L.

In some embodiments, colorants in the above system, method and packaged colorants are packaged in containers from which colorant is gravimetrically or volumetrically dispensed via an automated or manual colorant dispenser into base paints or stains in containers having a volume of about 0.2 to 20 L.

In some embodiments, the above point-of-sale custom color system and method also include at least one water-borne base paint or stain packaged in largely but incompletely filled point-of-sale containers equipped with an openable and recloseable lid, cap or other closure for an opening through which water-only liquid colorant may be dispensed from an automated or manual colorant dispenser into a base paint or stain.

In further embodiments, the above point-of-sale custom color system and method also include at least one solvent-borne base paint or stain packaged in largely but incompletely filled point-of-sale containers equipped with an openable and recloseable lid, cap or other closure for an opening through which water-only liquid colorant may be dispensed from an automated or manual colorant dispenser into a solvent-borne base paint or stain, and wherein the above-mentioned synergist (containing one or more ingredients that will disperse the water-only colorants into solvent-borne base paints or stains) is included in the solvent-borne base paint or stain or is added to the solvent-borne base paint or stain before, together with or (less preferably) after dispensing the water-only liquid colorant into the solvent-borne base paint or stain. In additional embodiments, the point-of-sale custom color system includes an air-oxidizable solvent-borne base paint or stain and a siccative that accelerates the curing time of air-oxidizable (e.g., alkyd) materials contained within the base paint or stain.

The present disclosure provides, in another aspect, an at least three-component surfactant package for use in making water-only liquid colorants for tinting water-borne base paints and stains, the package comprising a mixture of surfactants having Formulas I, II and III below:

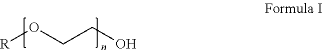

where R is a linear or branched chain alkyl group or mixture of groups having 1-20 carbons, and n is the number of moles of ethylene oxide and is at least 7 and up to 50;

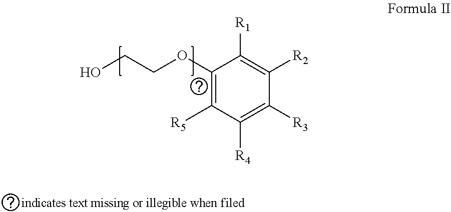

where m is the number of moles of ethylene oxide and is at least 5 and up to 25, and in some embodiments is at least 10 and up to 20; and R₁, R₂, R₃, R₄ and R₅ are independently hydrogen or linear or branched aliphatic or aromatic hydrocarbon groups containing at least 4 and up to 10 carbon atoms; and

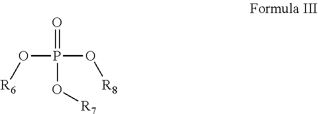

where R₆ is hydrogen or an ethylene oxide chain containing at least 5 and up to 15 moles and a terminal hydrogen atom, nitrogen group, alkyl group or alkaryl group, and R₇ and R₈ are independently hydrogen, sodium, potassium, a counter ion, or an ethylene oxide chain containing at least 5 and up to 15 moles EO and a terminal hydrogen atom, alkyl group or alkaryl group.

In some embodiments the disclosed surfactant package comprises a mixture of:
a) alcohol ethoxylate having a hydrophile-lipophile balance (HLB value) of 12 to 20;
b) tristyryl phenol ethoxylate with 5 to 15 moles ethylene oxide; and
c) aliphatic phosphate ester with 5 to 15 moles ethylene oxide.

The disclosed system, method and surfactant package permit point-of-sale formulation and sale of both water-borne and solvent-borne custom-tinted paints and stains using a single tinting machine and a single colorant array, while avoiding or minimizing added inventory, dedicated dispensers or dedicated floor space.

### BRIEF DESCRIPTION OF THE DRAWING

FIG. 1 and FIG. 2 are perspective views of embodiments of the disclosed paint or stain tinting system; and

FIG. 3 is a schematic view of an embodiment of the disclosed colorant array and the disclosed synergist.

Like reference symbols in the various figures of the drawing indicate like elements. The elements in the drawing are not to scale.

### DETAILED DESCRIPTION

Unless the context indicates otherwise the following terms shall have the following meaning and shall be applicable to the singular and plural:

The terms “a,” “an,” “the,” “at least one,” and “one or more” are used interchangeably. Thus, for example, a system or method that includes “a” pigment means that the system or method may include “one or more” pigments.

The terms “architectural paints” and “architectural stains” respectively mean paints and stains for use on interior or exterior building or construction surfaces, e.g., walls, trim, floors, decks, railings, ceilings, roofs (including metal roofing, shingles and tiles), roadways, sidewalks, etc.

The term “array” when used with respect to colorants means an assortment of colorants intended to be used individually or in appropriate combinations to tint base paints or stains so as to provide user-customized colors in a wide gamut of hues. A typical array will normally contain at least white, green, blue and red colorants, and usually will also contain one or more black colorants, one or more yellow colorants and one or more oxide colorants such as red oxide or yellow oxide. The individual colorants in a typical array will normally be supplied by a single manufacturer, be packaged in similar containers, bear similar labels each having a distinct SKU identifier, and may bear a unifying trademark for the array or for the brand of paint or stain with which the array is intended to be used.

The term “automated colorant dispenser” means a dispenser for paint or stain colorants which is controlled or controllable via electronically-regulated precision gravimetric weighing or volumetric metering devices so as to dispense controlled quantities of one or more colorants (e.g., water-only colorants) into a base paint or stain container and thereby facilitate preparation of tinted paints or stains whose tints are selected from an array of tints. The colorant types and amounts selected by such an automated colorant dispenser will optionally and preferably be controlled using software and a suitable database.

The term “base paint or stain” means a water-borne or solvent-borne paint or stain product packaged in a largely but incompletely filled point-of-sale container with a volume of about 0.2 to 20 L equipped with an openable and recloseable lid, cap or other closure, and which may be used as is but normally will be tinted at the point-of-sale by adding one or more colorants to the paint or stain product in its container, and stirring, shaking or otherwise mixing the container contents to compatibly and homogeneously disperse the colorant throughout the base paint or stain product.

The term “binder” means a film-forming natural or synthetic polymer suitable for use in a paint or stain.

The term “colorant” means a composition that can be added to (e.g., dispensed into) a point-of sale container whose interior volume is largely (e.g., two thirds of the container volume or more) but not completely already filled with a base paint or stain so as to alter the hue or lightness of such base paint or stain, and which contains pigment and a vehicle but is substantially free of binder.

The terms “compatible” and “compatibly” when used with respect to a colorant mean that if 4 fluid oz. of the colorant is added to a nominal (128 fluid oz.) gallon of base paint or stain and shaken for five minutes on a standard paint shaker, the colorant is dispersed throughout the base paint or stain and does not undergo visibly discernible separation when allowed to stand for one week at room temperature.

The term “custom-tinted” when used with respect to a system or method for tinting base paints or stains means that one or more colorants can be dispensed into a base paint or stain and mixed to provide finished paint or stains in a wide variety of (e.g., more than one hundred or even more than one thousand) preselected formulated colors or, if desired, a match for randomly-selected colors. The preselected formulated colors will ordinarily be viewed by potential end users using printed color charts or displayed computer images.

The term “headspace” when used with respect to a base paint or stain in an openable container refers to an unfilled small portion of the total container volume (for example, about 1% to about 33%, and in some embodiments about 1% to about 15%, of the total container volume) available for and intended to be used for colorant addition.

The terms “homogeneous” and “homogeneously” when used with respect to a colorant mean that if 4 fluid oz. of the colorant is added to a nominal (128 fluid oz.) gallon of base paint or stain and shaken for five minutes on a standard paint shaker, the colorant is uniformly dispersed throughout the base paint or stain without visibly discernible separation.

The term “liquid” when used to describe a material that can exist in several different phases refers to the phase occupied by that material at room temperature (23° C.) and 1 atm.

The terms “low volatile organic compound” and “low VOC” when used with respect to a colorant, paint or stain means that the colorant, paint or stain when in liquid form contains less than 50 grams per liter (g/L) of volatile compounds of carbon according to Rules 102 and 113 of the California South Coast Air Quality Management District (as amended in February 2016).

The term “manual colorant dispenser” means a non-automated dispenser for paint or stain colorants which is equipped with manually-movable pistons whose strokes have been indexed to manually meter quantities of one or more colorants into a base paint or stain container and thereby facilitate preparation of tinted paints or stains whose tints are selected from an array of tints.

The term “molecular weight” when used in reference to a polymeric material means the number average molecular weight as determined using gel permeation chromatography and a polystyrene standard.

The term “NVM” is an abbreviation for non-volatile materials, and refers to a material that does not significantly evaporate at standard temperature and pressure. NVM content may be evaluated using ASTM D1353-13.

The term “paint” means a coating composition including pigment and binder which when applied to form a thin (e.g., 100 μm) wet thickness coating film on a freshly-sanded smooth wood surface, will when dried hide or substantially hide the wood grain and will present a new surface with its own appearance.

The term “pigment” means both colored, dispersible solid particulate materials and (in the interest of brevity) also colored dispersible or soluble dye materials, wherein the material imparts visually noticeable color to a base paint or stain when 5 wt. % (in the case of a colored, dispersible solid particulate) or 0.05 wt. % (in the case of a colored, dispersible or soluble dye) of the material is added to (e.g., dispensed into) the base paint or stain. The presence or absence of visually noticeable color may be assessed by preparing drawdown samples of the base paint or stain with and without the pigment, casting such samples as 25 μm dry thickness coated films over the white part of a BYK-Gardner No. PA-2811 opacity drawdown chart (from BYK-Gardner USA) or comparable chart, and examining the coated films under normal overhead interior illumination.

The term “pigment volume concentration” when used in respect to a paint, stain or colorant means the total percentage of dried coating volume occupied by all pigment species in the coating.

The terms “point-of-sale” and “retail” when used with respect to a site, location, store or other outlet means a place at which custom-mixed paints or stains are tinted and mixed in small batch lots (e.g., one half pint, one pint, one quart, one liter, one gallon, four liter, five gallon or 20 liter containers, corresponding to containers from about 0.2 to 20 L) for sale to end-users (e.g., painters, builders and homeowners). Representative point-of-sale retail, wholesale or combined retail/wholesale outlets include paint stores, hardware stores, building supply stores (including warehouses), and distribution centers.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

The term “primarily or exclusively”, when used with respect to the amount of ingredients in a synergist, means in the case of the word “primarily” that the named ingredient or ingredients represent at least 50 wt. % of the ingredients in such synergist, excluding any solvent or other carrier (e.g., water) that may be present in the synergist. In some embodiments the named ingredient or ingredients may represent at least 60 wt. %, at least 70 wt. %, at least 80 wt. % or at least 90 wt. % of the ingredients in such synergist, excluding such solvent or other carrier. In the case of the word “exclusively”, the synergist consists essentially of or consists of such named ingredients, excluding such solvent or other carrier.

The term “siccative” means an additive dispersible within an air-oxidizable solvent-borne base paint or stain that accelerates the curing time of air-oxidizable (e.g., alkyd) materials contained within the base paint or stain. Without being bound by theory, such siccatives are believed to accelerate such curing time by catalyzing the free-radical autoxidation of conjugated double bonds contained therein when exposed to air.

The term “siccative-free” when used in the context of a siccative-free synergist or base paint or stain means a representative component formulated without including a siccative. In some embodiments, a siccative-free composition may be the same as a composition that is substantially free of siccative materials.

The term “solid” when used to describe a material that can exist in several different phases refers to the phase occupied by that material at room temperature (23° C.) and 1 atm.

The term “solvent” when used in respect to a paint, stain or colorant means an organic liquid that dissolves or disperses other substances in the paint, stain or colorant, and is deemed to include both volatile and non-volatile and both reactive and non-reactive substances.

The term “solvent-borne” when used in respect to a paint, stain or colorant means that the major liquid vehicle or carrier for the paint, stain or colorant is a nonaqueous solvent or mixture of nonaqueous solvents.

The term “stain” means a coating composition including binder which when applied to form a thin (e.g., 100 μm) wet thickness coating film on a freshly-sanded smooth wood surface, will when dried not hide both the wood grain and its texture. When a semi-transparent stain is applied to wood, the wood grain and its texture normally both remain noticeable, whereas when a solid color (viz., opaque) stain is applied the grain normally becomes hidden while the texture normally remains noticeable. A stain typically will soak into a wood or other porous substrate (e.g., concrete) to a much greater extent than will a paint.

The term “substantially free of” when used with respect to an ingredient or composition means that the referenced ingredient or composition contains less than 0.1 wt. % of the recited component. The term “completely free” of a particular compound means that the recited material or composition contains less than 100 parts per million (ppm) of the compound.

The terms “tint strength” and “tinting strength” refer to the value obtained using spectrophotometric instrumentation such as, but not limited to, a Datacolor DC500, DC800 or similar spectrophotometer, a D65 illuminant, CIE 1964 10° Standard Observer angle and reflectance mode.

The term “uncolored” when used with respect to a synergist means that the synergist does not contain visually noticeable quantities of pigment. A synergist may however have its own inherent color, such as the yellow coloration sometimes found in amine group-containing surfactants or provided by certain siccatives.

The term “water-borne” when used in respect to a paint, stain or colorant means that the major liquid vehicle or carrier for the paint, stain or colorant is water.

The term “water-only” when used with respect to a liquid colorant means that the colorant can be used to tint a water-borne base paint or stain, but exhibits objectionable rub-up (viz., unsatisfactory compatibility and homogeneity) when added by itself in an attempt to tint a conventional solvent-borne paint (such as SWP™ Exterior Oil Base Paint Tinting White, Product No. A02W00528) or a conventional solvent-borne stain (such as Cabot™ Semi-Transparent Deck & Siding Stain Neutral Base No. 306). Rub-up may be evaluated using the Rub-Up Test shown below in the Examples section. Objectionable rub-up corresponds to a Moderate or Severe rating in the Rub-Up Test. A skilled paint tinting technician would regard a water-only colorant as being a “non-universal” colorant, and would regard a universal colorant as not being a water-only colorant.

The recitation of a numerical range using endpoints includes all numbers subsumed within that range (e.g., 1 to 5 includes 1, 1.5, 2, 2.75, 3, 3.80, 4, 5, etc.).

The disclosed surfactant package includes at least three surfactants. We have found when using water-only colorants to tint water-borne paints and stains that a surfactant package containing three or more surfactants can provide better tinted paint and stain performance compared to water-only colorants containing only one or two surfactants. Normally, only a single surfactant is required in a water-only colorant to compatibly mix such colorant into a water-borne paint or stain. Exemplary surfactants that may be used in the disclosed surfactant package include anionic, amphoteric and nonionic materials available from a variety of suppliers including 3M, Air Products and Chemicals, Inc., Akzo Nobel, Ashland, BASF, Dow Chemical Co., E. I. DuPont de Nemours and Co., Elementis Specialties, Inc., Harcros Chemicals, Rhodia and Solvay, such as the TAMOL™ series from Dow Chemical Co., nonyl and octyl phenol ethoxylates from Dow Chemical Co. (e.g., TRITON™ X-45, TRITON X-100, TRITON X-114, TRITON X-165, TRITON X-305 and TRITON X-405) and other suppliers (e.g., the T-DET N series from Harcros Chemicals), alkyl phenol ethoxylate (APE) replacements from Dow Chemical Co., Elementis Specialties, Inc. and others, various members of the SURFYNOL™ series from Air Products and Chemicals, Inc. (e.g., SURFYNOL 104, SURFYNOL 104A, SURFYNOL 104BC, SURFYNOL 104DPM, SURFYNOL 104E, SURFYNOL 104H, SURFYNOL 104PA, SURFYNOL 104PG50, SURFYNOL 104S, SURFYNOL 2502, SURFYNOL 420, SURFYNOL 440, SURFYNOL 465, SURFYNOL 485. SURFYNOL 485W, SURFYNOL 82, SURFYNOL CT-211, SURFYNOL CT-221, SURFYNOL OP-340, SURFYNOL PSA204, SURFYNOL PSA216, SURFYNOL PSA336, SURFYNOL SE and SURFYNOL SE-F), various fluorocarbon surfactants from 3M, E. I. DuPont de Nemours and Co. and other suppliers, and phosphate esters from Ashland, Rhodia and other suppliers. The individual types and amounts of these and other surfactants typically will be empirically selected for each colorant in an array, based on colorant performance factors including storage stability, compatibility and ease of use with water-borne paints and stains, and performance of the desired tinted water-borne paint or stain following colorant addition.

In some embodiments, the disclosed surfactant package includes at least two nonionic surfactants and at least one anionic surfactant. The nonionic surfactants desirably include a hydrophilic alkylene oxide portion (e.g., an ethylene oxide portion containing a plurality of —CH₂CH₂O— groups) and a hydrophobic portion, with the hydrophobic portion of at least one of the nonionic surfactants containing a linear or branched chain aliphatic group (e.g., an alkyl group or mixture of alkyl groups having 1-20 carbons), and the hydrophobic portion of at least another of the nonionic surfactants containing one or more aromatic rings (e.g., 1, 2, 3, 4 or more six-carbon aromatic rings). In some embodiments all three of the at least three surfactants have a number average molecular weight less than 2,000 g/mol. The anionic surfactant(s) desirably include a hydrophilic alkylene oxide portion (e.g., an ethylene oxide portion containing a plurality of —CH₂CH₂O— groups) and a hydrophobic portion, with the hydrophobic portion desirably including a phosphorus group (e.g., a phosphate ester group) or a sulfur group (e.g., a sulfate or sulfonate group). In some embodiments, the disclosed surfactant package includes surfactants having Formulas I, II and III below:

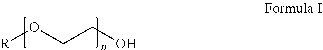

where R is a linear or branched chain alkyl group or mixture of groups having 1-20 carbons, and n is the number of moles of ethylene oxide and is at least 7 and up to 50;

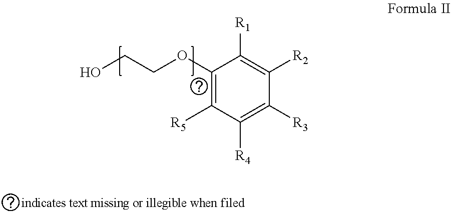

where m is the number of moles of ethylene oxide and is at least 5 and up to 25, and in some embodiments is at least 10 and up to 20; and R₁, R₂, R₃, R₄ and R₅ are independently hydrogen or linear or branched aliphatic or aromatic hydrocarbon groups containing at least 4 and up to 10 carbon atoms; and

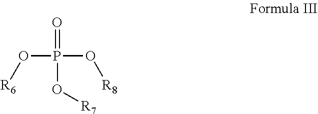

where R₆ is hydrogen or an ethylene oxide chain containing at least 5 and up to 15 moles and a terminal hydrogen atom, nitrogen group, alkyl group or alkaryl group, and R₇ and R₈ are independently hydrogen, sodium, potassium, a counter ion, or an ethylene oxide chain containing at least 5 and up to 15 moles EO and a terminal hydrogen atom, alkyl group or alkaryl group.

In some embodiments the disclosed surfactant package includes an alcohol ethoxylate having a hydrophile-lipophile balance (HLB value) of 12 to 20, a tristyryl phenol ethoxylate with 5 to 15 moles ethylene oxide and an aliphatic phosphate ester with 5 to 15 moles ethylene oxide.

Set out below in Table I is a list of commercially available surfactants that may be used in the disclosed surfactant package:

TABLE I

| | | Physical | Alkyd | Latex | |
|---|---|---|---|---|---|
| Surfactant | Description | Form | Compat. | Compat. | Formula |
| TERGITOL ™ 15-S-9 | secondary alcohol | liquid | x | x | I |
| Surfactant (from Dow | ethoxylate | | | | |
| Chemical Company) | | | | | |
| ABEX ™ 2545 (from | proprietary | liquid | | x | I |
| Rhodia Solvay Group) | nonionic | | | | |
| | surfactant | | | | |
| NOVEL ™ 23E7 | alcohol | liquid | x | x | I |
| Ethoxylate (from | ethoxylate | | | | |
| Rhodia Solvay Group) | | | | | |
| NOVEL 23E9 | alcohol | liquid | x | x | I |
| Ethoxylate (from | ethoxylate | | | | |
| Rhodia Solvay Group) | | | | | |
| EMULSOGEN ™ | ethoxylated | liquid | x | x | II |
| TS100 (from Clariant) | tristyrylphenol | | | | |
| EMULSOGEN TS200 | ethoxylated | liquid | x | x | II |
| (from Clariant) | tristyrylphenol | | | | |
| ENVIOMET ™ EM | ethoxylated | liquid | x | x | II |
| 2014 (from Innospec) | tristyrylphenol | | | | |
| ENVIOMET EM | ethoxylated | liquid | x | x | II |
| 2016 (from Innospec) | tristyrylphenol | | | | |
| ENVIOMET EM | ethoxylated | liquid | x | x | II |
| 2020 (from Innospec) | tristyrylphenol | | | | |
| MAKON ™ TSP-12 | polyarylphenol | liquid | x | x | II |
| (from Stepan) | ethoxylate | | | | |
| MAKON TSP-16 | polyarylphenol | liquid | x | x | II |
| (from Stepan) | ethoxylate | | | | |
| POLYSTEP ™ | ethoxylated | liquid | x | x | II |
| TSP-16 (from Stepan) | tristyrylphenol | | | | |
| SOPROPHOR ™ | ethopropoxylated | liquid | x | x | II |
| 796 P (from Rhodia | polyarylphenol | | | | |
| Solvay Group) | | | | | |
| SOPROPHOR | ethoxylated | liquid | x | x | II |
| BSU (from | tristyrylphenol | | | | |
| Rhodia Solvay Group) | | | | | |
| SOPROPHOR | ethoxylated | liquid | x | x | II |
| CY 8 (from | tristyrylphenol | | | | |
| Rhodia Solvay Group) | | | | | |
| SOPROPHOR | ethoxylated | liquid | x | x | II |
| S25 (from | tristyrylphenol | | | | |
| Rhodia Solvay Group) | | | | | |
| SOPROPHOR | ethoxylated | liquid | x | x | II |
| TS-10/VS-2 (from | tristyrylphenol | | | | |
| Rhodia Solvay Group) | | | | | |
| Tristyrylphenol | ethoxylated | liquid | x | x | II |
| Ethoxylate (from | tristyrylphenol | | | | |
| Parchem) | | | | | |
| YELKIN ™ TS Soya | lecithin | liquid | x | | III |
| Lecithin Unbleached | | | | | |
| (from Archer Daniels | | | | | |
| Midland Co.) | | | | | |
| CENTROLEX F ™ | oil-free dry | Solid | x | | III |
| powder (from Central | lecithin | | | | |
| Soya Company Inc.) | | | | | |
| HOSTAPHAT ™ | phosphate ester | liquid | x | x | III |
| 1306 (from Clariant) | | | | | |
| SOLEC ™ F Deoiled | dry lecithin | solid | x | | III |
| Soy Lecithin Powder | | | | | |
| (from DuPont Danisco) | | | | | |
| LUBRHOPHOS ™ | linear alcohol | liquid | x | x | III |
| LK 500 (from | ethoxy phosphate | | | | |
| Rhodia Solvay Group) | | | | | |
| RHODAFAC ™ PL-6 | linear alcohol | liquid | x | x | III |
| (from Rhodia | ethoxy phosphate | | | | |
| Solvay Group) | | | | | |
| RHODAFAC PL-620 | linear alcohol | liquid | x | x | III |
| (from Rhodia | ethoxy phosphate | | | | |
| Solvay Group) | | | | | |
| RHODAFAC RA-600 | linear alcohol | liquid | x | x | III |
| (from Rhodia | ethoxy phosphate | | | | |
| Solvay Group) | | | | | |
| RHODAFAC RS-410 | branched alcohol | liquid | x | x | III |
| (from Rhodia | ethoxy phosphate | | | | |
| Solvay Group) | | | | | |
| RHODAFAC RS-610 | branched alcohol | liquid | x | x | III |
| (from Rhodia | ethoxy phosphate | | | | |
| Solvay Group) | | | | | |
| RHODAFAC RS-710 | branched | liquid | x | | III |
| (from Rhodia | alcohol ethyoxy | | | | |
| Solvay Group) | phosphate ester | | | | |
| RHODAFAC RS-960 | branched alcohol | liquid | x | x | III |
| (from Rhodia | ethoxy phosphate | | | | |
| Solvay Group) | | | | | |
| SOPROPHOR ™ | tristyrylphenol | liquid | x | x | III |
| 3D/33 (from Rhodia | ethoxy phosphate | | | | |
| Solvay Group) | | | | | |
| Lecithin (e.g., canola | phospholipid | liquid | x | x | III |
| or soybean lecithin, | | | | | |
| from various suppliers) | | | | | |

Set out below in Table II is a list of additional commercially available surfactants that may be used in the disclosed colorants:

TABLE II

| | | Physical | Alkyd | Latex |
|---|---|---|---|---|
| Surfactant | Description | Form | Compat. | Compat. |
| HYDROPALAT ™ | difunctional | liquid | | X |
| WE 3135 | block copolymer | | | |
| (from BASF) | terminating | | | |
| | in primary | | | |
| | hydroxyl groups | | | |
| HYDROPALAT | difunctional | liquid | | X |
| WE 3167 | block copolymer | | | |
| (from BASF) | terminating | | | |
| | in primary | | | |
| | hydroxyl groups | | | |
| HYDROPALAT | difunctional | liquid | | X |
| WE 3317 | block copolymer | | | |
| (from BASF) | terminating | | | |
| | in primary | | | |
| | hydroxyl groups | | | |
| TETRONIC ™ 904 | tetrafunctional | paste | | X |
| (from BASF) | block copolymer | | | |
| | terminating | | | |
| | in primary | | | |
| | hydroxyl groups | | | |
| BYK ™ 2015 | solution of a | liquid | | X |
| (from Byk Altana) | structured | | | |
| | acrylate | | | |
| | copolymer | | | |
| | with pigment | | | |
| | affinic groups | | | |
| DISPERBYK ™ | copolymer with | liquid | x | X |
| 102 (from | acidic groups | | | |
| Byk Altana) | | | | |
| DISPERBYK 190 | solution of a | liquid | | X |
| (from Byk Altana) | high molecular | solution | | |
| | weight block | | | |
| | copolymer with | | | |
| | pigment affinic | | | |
| | groups | | | |
| DISPERBYK 2091 | modified poly- | liquid | x | X |
| (from Byk Altana) | alkoxylate with | | | |
| | neutral pigment | | | |
| | affinic groups | | | |
| DISPERBYK 2095 | salt polyamine | liquid | x | X |
| (from Byk Altana) | amides and | | | |
| | polyesters | | | |
| SMA 1440H (from | styrene maleic | liquid | x | X |
| Cray Valley) | anhydride | solution | | |
| | copolymer | | | |
| | solution | | | |
| AEROSOL ™ | sodium dioctyl | solid | x | X |
| OT-100 (from | sulfosuccinate | | | |
| Cytec Industries) | | | | |
| TAMOL ™ 165A | hydrophobic | liquid | | X |
| Dispersant (from | copolymer | | | |
| Dow Chemical | polyelectrolyte | | | |
| Company) | | | | |
| TAMOL 731A | Na salt of a | liquid | | X |
| 25% (from | maleic anhydride | solution | | |
| Dow Chemical | copolymer | | | |
| Company) | | | | |
| TEGO ™ | solution of a | liquid | | X |
| Dispersant | copolymer with | solution | | |
| 750 W (from | pigment affinic | | | |
| Evonik Resource | groups | | | |
| Efficiency GmbH) | | | | |
| SOLSPERSE ™ | 100% NVM | liquid | x | x |
| 67000 (from | polymeric | | | |
| Lubrizol Corp) | compatibiliser | | | |
| GEROPON ™ 99 | sodium dioctyl | liquid | x | x |
| (from Rhodia | sulfosuccinate | | | |
| Solvay Group) | (Solvay) | | | |
| GEROPON | sodium cocoyl | solid | x | x |
| AS-200 flake | isethionate | | | |
| (from Rhodia | | | | |
| Solvay Group) | | | | |
| GEROPON SDS | sodium dioctyl | solid | x | x |
| (from Rhodia | sulfosuccinate | | | |
| Solvay Group) | | | | |
| GEROPON T-22A | sodium methyl | liquid | x | x |
| (from Rhodia | oleyl taurate | | | |
| Solvay Group) | | | | |
| GEROPON T-77 | sodium oleyl | solid | x | x |
| (from Rhodia | N-methyl taurate | | | |
| Solvay Group) | | | | |
| PENTEX ™ 99 | sodium dioctyl | liquid | x | x |
| (from Rhodia | sulfosuccinate | | | |
| Solvay Group) | | | | |
| RHODACAL ™ | branched | liquid | x | x |
| 330 (from Rhodia | isopropylamine | | | |
| Solvay Group) | dodecylbenzene | | | |
| | sulfonate | | | |
| RHODACAL | sodium dibutyl | solid | x | x |
| BX-78 (from | naphthalene | | | |
| Rhodia Solvay | sulfonate | | | |
| Group) | | | | |
| RHODACAL | branched sodium | solid | x | x |
| DS-10 (from | dodecylbenzene | | | |
| Rhodia Solvay | sulfonate | | | |
| Group) | | | | |
| RHODACAL | linear | liquid | x | |
| IPAM (from | isopropylamine | | | |
| Rhodia Solvay | dodecylbenzene | | | |
| Group) | sulfonate | | | |
| RHODACAL N | sulfonated | solid | x | x |
| (from Rhodia | naphthalene | | | |
| Solvay Group) | condensate, | | | |
| | sodium salt | | | |
| RHODACAL | linear sodium | liquid | x | x |
| SSA/A (from | dodecylbenzene | | | |
| Rhodia Solvay | sulfonate | | | |
| Group) | | | | |
| RHODASURF ™ | dodecylphenol | liquid | x | x |
| BC-630 (from | ethoxylate | | | |
| Rhodia Solvay | | | | |
| Group) | | | | |
| RHODASURF | tridecyl alcohol | liquid | x | x |
| BC-720 (from | ethoxylate | | | |
| Rhodia Solvay | | | | |
| Group) | | | | |
| RHODOLINE ™ | 100% NVM | liquid | x | x |
| 3600 (from | proprietary | | | |
| Rhodia Solvay | compatibiliser | | | |
| Group) | | | | |
| RHODOLINE | proprietary | liquid | x | x |
| DP5817 (from | compatibiliser | | | |
| Rhodia Solvay | | | | |
| Group) | | | | |
| G-3300 Alkyl Aryl | alkyl aryl | liquid | x | |
| Sulfonate (from | sulfonate, | | | |
| Stepan Company) | isopropyl | | | |
| | amine salt | | | |

The colorants may for example contain at least about 0.5, at least about 1 or at least about 2 wt. %, and up to about 20, up to about 15 or up to about 10 wt. % of the disclosed surfactant package based on the total colorant weight. Different colorants may contain different overall amounts of the surfactant package, as well as different amounts or relative ratios of each individual surfactant. For example, in an array containing white, green, blue, red, yellow and black colorants and using a surfactant package containing surfactants of Formula I, Formula II and Formula III, improved performance may be obtained when the yellow and black colorants contain a greater amount of the surfactant package relative to the other colorants. Also, improved performance may be obtained when the white, green, blue, yellow and black colorants contain a greater amount of the Formula I surfactant relative to the amounts of Formula II or Formula III surfactants, and when the red colorant contains a greater amount of Formula III surfactant relative to the amounts of Formula I or Formula II surfactants.

A variety of water-only colorants may be used in the disclosed system and method. The water-only colorants normally will contain the disclosed surfactant package, one or more pigments, one or more vehicles or carriers, one or more pigment dispersing agents, and optional adjuvants, and will be in the form of pourable liquids. The colorants typically will not contain film-forming binders, and should be combined with a base paint or stain in order to provide a durable dried or cured finish.

A variety of pigments may be employed in the disclosed colorants (as well as in the base paints or stains), and will be familiar to persons having ordinary skill in the art. The pigments desirably form a stable dispersion that does not require agitation prior to use. In some instances a suitable pigment may also or instead be referred to commercially as a dye. Exemplary pigments include treated or untreated inorganic pigments and mixtures thereof, for example metallic oxides including titanium dioxide, iron oxides of various colors (including black) and zinc oxide; and metallic flakes such as aluminum flakes, pearlescent flakes, and the like. Exemplary pigments also or instead include treated or untreated organic pigments and mixtures thereof, for example carbon black, azo pigments, benzimidazolinones, carbazoles such as carbazole violet, diketopyrrolopyrroles, indanthrones, isoindolinones, isoindolons, perylenes, phthalocyanines, quinacridones and thioindigio reds. Suitable pigments are commercially available from a variety of commercial suppliers including BASF Colors & Effects GmbH, LANXESS, Cabot Corp, Ciba Specialty Chemicals, Clariant, Ferro Corporation, Shepherd Color Company, Sun Chemical and Tomatec America, Inc. Other exemplary pigments are described, for example, in U.S. Pat. Nos. 8,141,599 B2 (Korenkiewicz et al.), 8,746,291 B2 (Hertz et al.) and 8,748,550 B2 (Cavallin et al.). Colorants or colorant arrays containing entirely inorganic pigments or pigment mixtures may be preferred where custom-tinted paints or stains having maximum exterior durability are desired. In some embodiments, the colorant array includes non-infrared absorptive pigments for tinting dark exterior paints, and infrared-absorptive pigments for tinting dark interior paints, as described in U.S. Pat. No. 8,752,594 B2 (Gebhard et al.). The colorants may for example contain at least about 2, at least about 3 or at least about 5 wt. % pigment and up to about 90, up to about 80 or up to about 70 wt. % pigment.

The pigments may be supplemented with extenders, inert pigments or fillers such as talc, china clay, barytes, carbonates, silicates and mixtures thereof, for example magnesium silicates, calcium carbonate, aluminosilicates, silica and various clays; organic materials including plastic beads (e.g., polystyrene or polyvinyl chloride beads), microspherical materials containing one or more voids, and vesiculated polymer particles (e.g., those discussed in U.S. Pat. Nos. 4,427,835, 4,920,160, 4,594,363, 4,469,825, 4,468,498, 4,880,842, 4,985,064, 5,5157,084, 5,041,464, 5,036,109, 5,409,776, and 5,510,422). Other exemplary extenders, inert pigments or fillers include EXPANCEL™ 551DE20 acrylonitrile/vinyl chloride expanded particles (from Expancel Inc.), SIL-CEL™ 43 glass micro cellular fillers (from Silbrico Corporation), FILLITE™ 100 ceramic spherical particles (from Trelleborg Fillite Inc.), SPHERICEL™ hollow glass spheres (from Potter Industries Inc.), 3M ceramic microspheres including grades G-200, G-400, G-600, G-800, W-210, W-410, and W-610 (from 3M), 3M hollow microspheres including 3M Performance Additives iM30K (also from 3M), INHANCE™ UH 1900 polyethylene particles (from Fluoro-Seal Inc.), and BIPHOR aluminum phosphate (from Bunge Fertilizantes S. A., Brazil). The colorants may for example contain at least about 0.5, at least about 1 or at least about 2 wt. % combined weight of pigment, extender, inert pigment and filler and up to about 80, up to about 70 or up to about 60 wt. % combined weight of pigment, extender, inert pigment and filler.

A variety of vehicles or carriers may be employed in the disclosed colorants, and will be familiar to persons having ordinary skill in the art. Water is a preferred vehicle or carrier, and may for example be tap water, deionized water desalinated (e.g., via reverse-osmosis) water or distilled water. Cosolvents may assist in dispersing the pigment into the colorant or into a base paint or stain; may speed up, retard or otherwise change the time or emissions associated with drying; may improve wet edge properties or overlap characteristics; may improve freeze-thaw protection, or may provide or improve other features, and generally will not be retained in a film of the dried, cured or otherwise hardened paint or stain. A chosen cosolvent may be a hazardous air pollutant solvent (HAPS material) but preferably is a non-HAPS material or is substantially free of HAPS materials. Exemplary cosolvents typically have low molecular weights (e.g., up to about 700, up to about 600, up to about 500 or up to about 400 g/mol) and may for example include glycols (e.g., ethylene glycol, diethylene glycol, triethylene glycol, tetraethylene glycol and propylene glycol), glycol ethers (e.g., DOWANOL™ DPM and Butyl CELLOSOLVE™ from Dow Chemical Co.), alcohols (e.g., methanol, ethanol, n-propanol, isopropanol, n-butanol, isobutanol, 2-methyl butanol, isoamyl alcohol and other primary amyl alcohol isomers, n-pentanol, 2-ethylhexanol, 4-hydroxy-2,6,8-trimethylnonane and diisobutyl carbinol), esters and ester alcohols (e.g., isopropyl acetate; n-butyl acetate; isobutyl acetate; n-propyl acetate; primary amyl acetate mixed isomers, and UCAR™ Ester EEP from Dow Chemical Co.), ketones (e.g., diisobutyl ketone and

ECOSOFT™ Solvent IK from Dow Chemical Co.), CARBOWAX™ 300 and CARBOWAX 600 polyethylene from Dow Chemical Co., mixtures thereof and the like. The colorants may for example contain at least about 8, at least about 10 or at least about 12 wt. % vehicles or carriers, and up to about 70, up to about 60 or up to about 50 wt. % vehicles or carriers.

A variety of pigment dispersing agents may be employed in the disclosed colorants, and will be familiar to persons having ordinary skill in the art. Exemplary pigment dispersing agents include anionic polyelectrolyte dispersants such as maleic acid copolymers, acrylic acid copolymers including methacrylic acid copolymers, and carboxylic acids such as tartaric acid, succinic acid, citric acid, itaconic acid, mixtures thereof and other materials that will be familiar to persons having ordinary skill in the art. Some colorants in the array may not require pigment dispersing agents. Those colorants that do employ them may for example contain at least about 0.1, at least about 0.5 or at least about 1 wt. % pigment dispersing agent, and up to about 5, up to about 3 or up to about 2 wt. % pigment dispersing agent.

The disclosed surfactants are suitable for inclusion in one or more water-only colorants in a colorant array. The disclosed colorant array may in some instances be prepared by adding suitable additional surfactants to existing water-only fluid colorants produced by manufacturers such as Akzo Nobel, BASF, Behr Paint Company, Clariant, Color Corporation of America (a subsidiary of the present assignee), CPS Color, Inc., Evonik Industries, ICI, PPG and Sherwin-Williams, such as the NOVOCOLOR™ HPII 8600 and NOVOCOLOR HP 8900 colorant lines from Color Corporation of America, the GENNEX™ colorant line from Benjamin Moore and the ECOTONER™ colorant line from Sherwin-Williams. The thus-modified colorants may represent all or a portion of a particular product array. For example, an array of water-only colorants including at least white, green, blue and red colorants may be selected from the above-mentioned NOVOCOLOR HP 8900 product line by selecting no. 8900 White, either or both of no. 8920 or 8921 Phthalo Green, either or both of no. 8930 or 8932 Phthalo Blue, and either or both of no. 8942 Interior Red or 8951 Exterior Red. Additional colorants may, subject to the availability of suitable dispenser slots, be added to the array as desired. Exemplary such additional colorants include one or more yellow, orange, magenta, brown or black colorants from the colorant manufacturers mentioned above.

The disclosed system and method may for example employ 5, 6, 7, 8, 9, 10, 11, 12, 13, 14 or 15 colorants, but may employ as few as four colorants if a restricted (viz., relatively few hues and relatively low gamut) color space is acceptable. The disclosed system and method may employ more than 15 colorants if sufficient dispenser slots are available and additional colorant SKUs are acceptable. For example, the disclosed system and method may employ 16, 17, 18, 19, 20, 21, 22, 23 or 24 colorants.

When the available number of colorant dispenser canisters is limited (e.g., when using a 12 or fewer canister dispenser), the number of colorant SKUs may be reduced by recognizing that some individual colorants are themselves mixtures of pigments which may be replaced with a precisely-metered blend of individual colorants. For example, many custom color paint systems employ one or more earth-tone colorants variously referred to using names such as brown oxide, raw umber or umber. Although brown oxide colorant is sometimes referred to as being made from a single pigment (e.g., PBr7 natural iron oxide), it may actually have been made using a blend of red and yellow oxides (e.g., PR101 red iron oxide and PY42 yellow iron oxide) shaded with carbon black (e.g., PBk7 carbon black) to match a specific color target. Raw umber or umber earth-tone colorants (which may collectively be referred to as “raw umber” colorants) likewise may have been made from a blend of colored oxides and carbon black. These blends may be replaced by adding colorants wholly made from (or substantially wholly made from) appropriate individual pigments, so as to provide a paint or stain whose coloration is like the coloration that would be obtained using a traditional blended pigment colorant. This may be done by using an automated colorant dispenser having a suitably low minimum fluid dispensing quantity (e.g., a minimum fluid dispensing quantity less than 0.01 fluid ounce (<0.3 mL)) so as to enable dispensing of small quantities of the individual colorants. Further details regarding the manner in which such blends may be dispensed may be found in the above-mentioned U.S. Pat. No. 8,141,599 B2. For example, a blend made using precisely-metered small amounts of yellow oxide pigment, red oxide pigment and black pigment may be dispensed into the base paint or stain whenever a tinted paint or stain with a brown oxide or raw umber tint is required.

The colorants optionally may contain a variety of adjuvants that will be familiar to persons having ordinary skill in the art. Representative adjuvants are described in Koleske et al., Paint and Coatings Industry, April 2003, pages 12-86. Exemplary adjuvants and commercial examples thereof include biocides, fungicides, mildewcides and preservatives (e.g., BUSAN™ 1292 from Buckman Laboratories, Inc., NOPCOCIDE™ N-40D from Cognis, KATHON™ LX from Rohm & Haas, and POLYPHASE™ 663, POLYPHASE 678 and POLYPHASE PW-40 from Troy Corporation); buffering agents and pH adjusters; defoamers; humectants; light stabilizers (e.g., hindered amine light stabilizers such as TINUVIN™ 123-DW and TINUVIN 292 HP from Ciba Specialty Chemicals); optical brighteners; thickeners; ultraviolet light absorbers (e.g., TINUVIN 234 and TINUVIN 1130 from Ciba Specialty Chemicals); wetting agents (e.g., BYK™ 346 and BYK 348 from Altana, PENTEX™ 99 from Rhodia and TROYSOL LAC™ from Troy corporation); and the like. The amounts and types of such adjuvants typically will be empirically selected, while bearing in mind that the colorants preferably will be non-settling and low VOC and these goals may be affected by the choice and amount of any adjuvants.

The disclosed colorants desirably have PVC values of at least about 0.1 vol. %, at least about 0.5 vol. % or at least about 1 vol. %, and up to about 25 vol. %. The amount of colorant(s) dispensed into a 1 gallon (3.78 L) nominal container of base paint or stain will vary in part depending on the base paint, stain or colorant PVC values and may for example range from about 0.00065 fluid ounces (0.19 mL) to about 16 fluid ounces (473 mL) of colorant addition, with larger amounts typically being employed in a clear base paint or stain or in a larger base paint or stain container, and smaller amounts typically being employed in a white base paint or stain or in a smaller base paint or stain container. The finished tinted paints or stains may for example have PVC values of at least about 0.5 or at least about 1 vol. %, and may for example have PVC values of up to about 85 vol. % or up to about 50 vol. %.

The colorant array may if desired include one or more solvent-borne colorants. Preferably however, all of the colorants in the array and in the colorant dispenser are water-borne colorants. In some embodiments, the majority or even all of the colorants in the array and in the colorant dispenser are water-only fluid colorants. In other embodiments, less than two, less than one or none of the colorants in the array and in the colorant dispenser are compatible with alkyd paints and stains, and the remaining colorants in the array will exhibit visually objectionable rub-up or insufficient tint strength if dispensed into such alkyd paints and stains without the above-mentioned synergist when added in representative tinting amounts of about 1 to about 15% of the alkyd paint or stain container volume.

The disclosed colorants (and optionally the above-mentioned synergist, siccative, or mixture thereof) typically will be packaged in containers suitable for use in the chosen colorant dispenser(s), and sold to the dispenser owner or operator in a point-of-sale custom tinting facility rather than to the end user of a custom-tinted paint or stain. Exemplary small batch lot container sizes are about 0.5, 1, 2 or 3 quarts; about 1 gallon; or about 0.5, 1, 2, 3, 4 or 5 liters, corresponding to containers from about 0.5 to about 5 L. Exemplary containers include boxes, cans, cartridges, jars, pouches (e.g., sealed pouches made of metal or plastic), squeeze bottles, syringes, tubes (e.g., collapsible tubes such as toothpaste-style tubes made of metal or plastic, and more rigid tubes equipped with movable pistons or plungers such as caulking-style tubes made of metal, plastic or paper) and other containers in which the colorants, synergists and siccatives can be sealed for storage, shipment and use. The colorants, synergist, and siccative may for example be supplied to the dispenser owner or operator in a can or other sealed container designed to be opened using a can opener or other can-puncturing device. The containers may also or instead be equipped with a manually-openable closure such as an openable and recloseable cap, or may be equipped with an irreversibly openable closure such as a tear-off seal or rupturable septum. As supplied to the dispenser owner or operator, the colorant container typically will include little or no headspace.

In order to replace an empty container in a colorant dispenser, a fresh colorant container may be placed in an appropriate slot or other receptacle or poured into an appropriate hopper or other vessel in the colorant dispenser so that the desired colorant may be dispensed in controlled amounts. In any event, once the container has been opened, colorant may be dispensed via the colorant dispenser into the available headspace of a base paint or stain container. Desirably the colorant container, colorant dispenser or both have a nozzle, adapter orifice or other design that facilitates clean entry of the colorant, siccative, or synergist into the colorant dispenser with minimal spillage or waste before or after use.

A variety of synergists may be used in the disclosed system and method, and are described for example in the above-mentioned U.S. Pat. Nos. 10,933,389 B2, 10,934,151 and International Application Publication No. WO 2022/011012 A1. The synergist may contain a variety of surfactants (e.g., nonionic, anionic, cationic or amphoteric surfactants), optional dispersing agents, and optional cosolvents. Exemplary dispersing agents and cosolvents include the dispersing agents and cosolvents discussed above. Exemplary synergists also include some of the ingredients that have been used or recommended for use in universal paint colorants, such as those described in U.S. Pat. No. 2,878,135 (Willis), 6,287,377 B1 (Binns et al.), 7,659,350 B2 (Coward et al.), 9,080,030 B2 (Amiel et al.), U.S. Patent Application Publication No. US 2016/0333213 A1 (Zhou et al.) and Published International Application No. WO2016040641 A1 (Donlon et al.). The synergist preferably is a low VOC material but in view of the intended use in solvent-borne base paints and stains, low VOC properties are not required. In some embodiments the synergist will include one or more or two or more surfactants, with the surfactants being selected to provide improved colorant compatibility across a range of solvent-borne base paint or stain binders. In some embodiments the synergist optionally may include one or more dispersing agents, one or more cosolvents, or one or more dispersing agents and one or more cosolvents. The surfactants and optional dispersing agents may be solids or liquids. As will be appreciated by persons having ordinary skill in the art, the optional cosolvents will be liquids, and preferably low VOC liquids. When solid surfactants or solid optional dispersing agents are employed, they may if desired be combined with a liquid surfactant, dispersing agent, cosolvent or conventional carrier or solvent (preferably a low VOC carrier or solvent) to provide a liquid synergist.

Suitable synergists may be selected in a variety of ways, including empirical testing to identify surfactants, siccatives, dispersing agents or cosolvents that render the individual members of the desired water-only colorant array compatible with the desired base paints and stains; by selecting ingredients that have previously been used in universal colorants used in the paint and stain industry; or by choosing surfactants, siccatives, dispersing agents or cosolvents based upon structural considerations such as hydrophilicity, oliophilicity and the ability of the synergist to pull a water-only colorant into a solvent phase. In some embodiments, the disclosed system and method may employ at least two synergists, one being configured for use in light colored paints or stains (e.g., shades of white, pastel colors, or the like) and one being configured for use in dark colored paints or stains. Additionally, or alternatively, the disclosed system and method may employ more than one different synergist, each being optimized for use with paint or with stain, or each being optimized for use with different commercially available base paints or stains (e.g., different branded product lines of base paints or stains).

The synergist may if desired include one or more additional adjuvants, such as one or more rheology modifiers or thickeners. Other optional adjuvants include but are not limited to adhesion promoters, antioxidants, biocides, buffers, coalescing agents, defoamers, dispersants, dyes, extender fillers, humectants, leveling agents, neutralizers, optical brighteners, pearlescents, plasticizers, polymeric additives, preservatives, reactive diluents, tackifiers, ultraviolet stabilizers (e.g., hindered amine light stabilizers) and waxes. In some embodiments, the synergist consists essentially of or consists of surfactants, optional dispersing agents, optional cosolvents and optional rheology modifiers or thickeners. For example, the synergist may contain less than 5 wt. % or less than 1 wt. % of any other ingredients.

Sufficient synergist should be employed to provide the desired degree of colorant dispersion into the solvent-borne base paint or stain to be tinted, while leaving sufficient remaining headspace in the base paint or stain container to permit addition of the desired colorant amount. Expressed on a volumetric basis, exemplary synergist amounts may for example be at least about 2, at least about 4, at least about 6, at least about 8 or at least about 10 mL of synergist per liter of solvent-borne base paint or stain to be tinted, and up to about 60, up to about 50, up to about 40, up to about 30 or up to about 20 mL of synergist per liter of solvent-borne base paint or stain to be tinted. If made containing a combination of ingredients, the synergist preferably provides a stable, homogeneous, non-settling composition that can be mixed into the base paint or stain in such exemplary amounts using a conventional paint stirrer or shaker and without forming visible clumps after mixing.

A variety of siccatives may be used in the disclosed system and method, and are described for example in the above-mentioned International Application Publication No. WO 2022/011012 A1. Exemplary siccatives include metal-organic compounds that catalyze hardening of the air oxidizable solvent-borne base paints and stains. In some embodiments, siccatives may include metal carboxylate driers such as organometallic salts derived from salts or coordination compounds of hydrocarbon carboxylates with metal ions. The metallic raw material and one or more organic acids may be dissolved in a diluent to produces the organometallic salt. Exemplary organic acids may be natural or synthetic. Natural organic acids may include, but are not limited to, naphthenates (e.g., petroleum based derivatives), fatty acids (e.g., unsaturated oleates), tallates, and the like. Synthetic organic acids may include, but are not limited to, 2-ethylhexanoate, neodecanoate, isononanoates, and the like. In some examples, siccatives may be characterized as oil-drying agents or Japan driers because they help reduce the drying or cure times of solvent-borne base paints or stains.

The siccative may include one or more auxiliary, primary, or through drier materials. Primary driers function mainly by drying the surface of the coating composition (e.g., skinning) while leaving the coating underneath wet. Through driers can help ensure that the coating dries at a uniform rate throughout the body of the film not just at the surface by, for example, linking fatty acid chains in the composition via oxygen-metal-oxygen bridges leading to crosslink connections in the coating. Auxiliary driers are useful to modify the effects of other drier materials. Examples of primary drier metals which can be used as the siccative may include, but are not limited to, cobalt, manganese, iron, and vanadium. Examples of through drier metals which can be used as the siccative material may include, but are not limited to, aluminum, cerium, lithium, neodymium, potassium, strontium, and zirconium. Examples of auxiliary drier metals which can be used as the siccative material may include, but are not limited to, calcium, barium, and zinc. In preferred examples, the siccative may include one or more cobalt or iron based siccatives.

Additionally, or alternatively, it may be desirable to select a siccative that exhibits reduced color properties such that the inclusion of the siccative does not alter the color performance of base paint or stain or the added colorant. Iron based siccatives may be particularly preferred for light colored paints or stains due to their compatible or inconspicuous color characteristics and robust drying characteristics. Other siccatives, such as cobalt based siccatives may have a slightly colored (e.g., non-white) appearance and may be better suited in darker colored paints or stains.

In some embodiments, the synergist(s) and siccative(s) may be combined together as a pre-mixed mixture. For example, the synergist and siccative may be combined with one another and used in amounts sufficient to provide desirable drying times (e.g., about 1 to about 12 hours) in the solvent-borne base paint or stain to which the combination is added. The desired synergist and siccative amounts may for example depend on whether the base paint or stain is a quick drying or traditional drying product. In some embodiments, the mixture of synergist and siccative may include at least about 0.01 wt. %, at least about 0.5 wt, % or at least about 1 wt. % siccative, and up to about 20 wt. %, up to about 10 wt. % or up to about 5 wt. % siccative. In some embodiments, after the siccative is added to or dispersed within a tinted base paint or stain, the paint or stain may contain about 0.5 wt. % to about 10 wt. % total siccative based on a dry solids basis.

The synergist, siccative, or mixture thereof may be packaged and shipped in a variety of containers, including those discussed above in connection with the colorant. In some embodiments, the container for the synergist, siccative, or mixture thereof is like that used for the colorants, and can be installed in and dispensed from an available slot in the colorant dispenser. In other embodiments, the synergist, siccative, or mixture thereof is packaged and shipped in a container from which the respective component can be manually dispensed, such as a squeeze bottle or any of a number of other convenient packaging and dispensing containers that will be familiar to persons having ordinary skill in the art.

A variety of liquid base paints and stains may be used in the disclosed system and method, and will be familiar to persons having ordinary skill in the art. Suitable base paints or stains are described for example in the above-mentioned U.S. Pat. Nos. 10,933,389 B2, 10,934,151 B2 and International Application Publication No. WO 2022/011012 A1, the disclosures of which are incorporated herein by reference.

Exemplary commercially-available water-borne base paints and stains that can be used in the disclosed system include ARMSTEAD™, CORAL™, DULUX™ TRADE™ and FLEXA™ emulsion paints from Akzo Nobel; BEHR™, BEHR MARQUEE™ and BEHR PREMIUM™, PREMIUM PLUS™ and PREMIUM PLUS ULTRA™ latex paints from Behr Paint Company; BENJAMIN MOORE™, BENJAMIN MOORE ADVANCE™, BENJAMIN MOORE AURA™, BENJAMIN MOORE BEN™, BENJAMIN MOORE NATURA™ and BENJAMIN MOORE SELECT™ latex paints from Benjamin Moore & Co.; GENERATION™, GENERATION LX™, INTERLOK™, MATCH POINT™, RENEWXC™, REVO™, STATE HOUSE™, TOTAL ADVANTAGE™ and 360 COMPLETE COVERAGE™ latex or low VOC paints from McCormick Paints; GLIDDEN™, GLIDDEN PREMIUM™, GLIDDEN HIGH ENDURANCE™, GLIDDEN SPRED™, GLIDDEN DIAMOND™, MANOR HALL™ PORTER™, REGENCY™, WONDER-PURE™ and WONDER-TONES™ latex paints from PPG Industries, Inc.; and A-100™, DURATION™, DURAMAX™, EMERALD™ INFINITY™, MEDALLION, OPTIMUS™, OVATION™, PRISTINE™, RESERVE™, RESILIENCE™, SHERWIN-WILLIAMS™, SHOWCASE™, SUPERPAINT™ SIGNATURE™, ULTRA™, and VALSPAR™ latex paints and MINWAX™ Water Based Wood Stains from Sherwin-Williams.

Exemplary commercially-available solvent-borne base paints and stains that can be used in the disclosed system include GREAT FINISHES™ stains from Ace Hardware Corporation; DULUX™ and (outside the US) GIDDEN™ alkyd paints from Akzo Nobel; BEHR™ alkyd paints from Behr Paint Company; oil-based stains from McCormick Paints; MOORE SATIN IMPERVO™ alkyd paint from Benjamin Moore & Co.; WEATHER-SHIELD™ alkyd paints from Kelly-Moore Co., alkyd paints from Huarun Paints (China); BAR-OX™, VELOUR™ and (outside the US) GLIDDEN™ alkyd paints from PPG Industries, Inc.; SHERWIN-WILLIAMS PROCLASSIC™, PROMAR™ and VALSPAR ULTRA 4000™ alkyd paints and CABOT™, MINWAX and MINWAX WOOD FINISH™ stains from Sherwin-Williams; and PERMO-PAVE™ alkyd paints from Wattyl Australia Pty. Ltd.

A variety of manual or automated colorant dispensers may be used in the disclosed system and method, including the COROB™ D50 manual colorant dispenser with a 1/48 fluid ounce (0.62 mL) minimum dispensing capacity from CPS Color Equipment, Inc., the ACCUTINTER™ 1500, 2000, 7000 and 8000 series automated colorant dispensers with a 1/384 fluid ounce (0.077 mL) minimum dispensing quantity from Fluid Management, Inc., and the Sample Dispensing System automated colorant dispenser with a 1/1024 fluid ounce (0.029 mL) minimum dispensing quantity from Fluid Management, Inc. Additional automated paint or stain colorant dispensers include the COROB MODULA HF™ machine with a 1/192 fluid ounce (0.153 mL) minimum dispensing quantity from CPS Color Equipment, Inc., and the TATOCOLOR™ machine with a 1/384 fluid ounce (0.077 mL) minimum dispensing quantity from CPS Color Equipment, Inc. The chosen dispenser may for example have a minimum fluid dispensing quantity less than 0.01 fluid ounce (<0.3 mL), preferably less than 0.007 fluid ounce (<0.2 mL) and more preferably less than 0.005 fluid ounce (<0.15 mL). Dispensers with even smaller minimum dispensing quantities may be employed, e.g. less than 0.001 fluid ounce (<0.03 mL) or less than 0.0002 (<0.014 mL) minimum dispensing quantities, but such dispensers may also require longer amounts of time to prepare strong colors in large containers.

The disclosed custom-colored architectural paints and stains may be applied to a variety of substrates, e.g., asphalt (including asphalt composition shingles and membranes), cement, cement fiberboard and roofing tiles, ceramics, concrete, fabric, glass, metal, paper, plastic, wallboard and wood (including monolithic, engineered and veneered wood), and other substrates that will be apparent to persons having ordinary skill in the art.

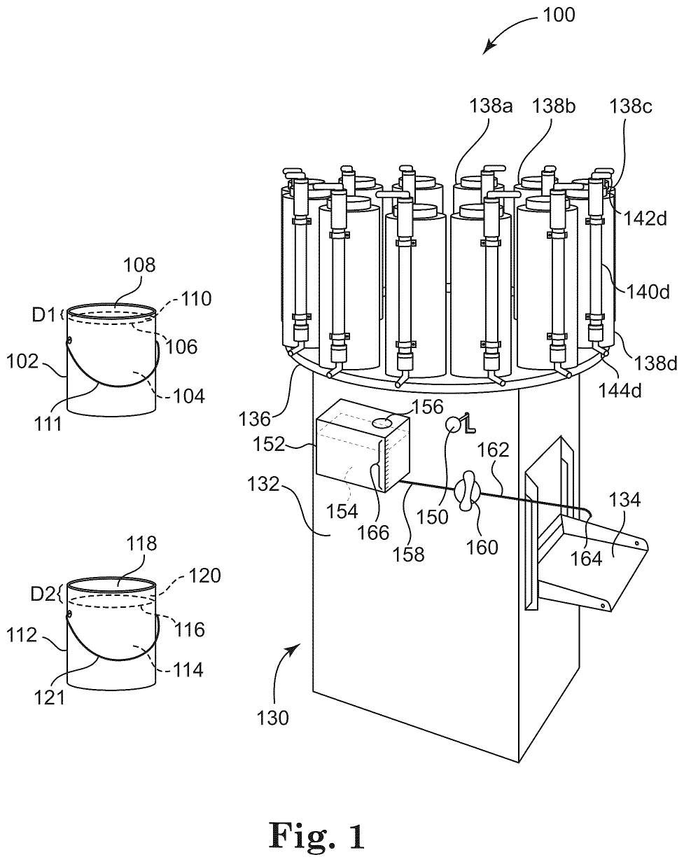

Referring now to the Drawing, FIG. 1 shows a perspective view of an embodiment 100 of the disclosed paint and stain mixing system. Container 102 holds a liquid water-borne base paint or stain 104. The upper surface 106 (shown in phantom view) of base paint or stain 104 is located a sufficient distance D1 below container lid 108 so that a headspace 110 is available for the addition of one or more colorants to prepare a custom-tinted water-borne paint or stain with a custom hue. Handle 111 may be used to carry container 102. Container 112 holds a liquid solvent-borne base paint or stain 114. The upper surface 116 (also shown in phantom view) of base paint or stain 114 is located a sufficient distance D2 below container lid 118 so that a headspace 120 is available for the addition of one or more colorants to prepare a solvent-borne paint or stain with a custom hue. Distance D2 may be greater than, less than or the same as distance D1, and will depend on the amount of colorants already present in base paints or stains 104 and 114 and the expected amount of colorant(s) that might need to be dispensed into base paints or stains 104 and 114 to obtain satisfactory final hues. Handle 121 may be used to carry container 112. The disclosed system and method may optionally employ a further base or bases (not shown in FIG. 1), for example a clear water-borne or solvent-borne base paint or stain for making deep colored custom tints.

Base paint or stain containers 102 and 112 may be combined with one or more colorants using, for example, manual colorant dispenser 130. Dispenser 130 includes cabinet 132 on which is mounted shelf 134 where containers 102 or 112 may be placed for colorant addition and if desired the addition of other ingredients such as a synergist, siccative, or combinations thereof. Turntable 136 includes a series of refillable dispenser canisters (twelve in this case, four of which are numbered as 138a, 138b, 138c and 138d) containing a point-of-sale array of liquid colorants in most or all of the canisters and optionally containing synergist, siccative, or synergist and siccative combined together as a mixture in one or more remaining canisters. In some embodiments, for example where it is desired to use all or nearly all available turntable positions for colorant addition, an optional synergist, siccative, or both may be dispensed into solvent-borne base paint or stain 114 using one or more separate bolt-on dispensers or a combination of a bolt-on dispenser and a canister such as canister 138a. An exemplary such dispenser is represented by reservoir 152 which may contain contents 154 (shown in phantom view) representing a synergist, siccative or mixture thereof. Reservoir 152 may be closed by removable cap 156 or other suitable closure, and may be refilled by removing such closure and pouring additional contents 154 into reservoir 152. Outlet conduit 158, manually-operated valve 160 and dispensing spout 162 may be used to dispense contents 154 into container 112 from spout 164. The amount of contents 154 added to container 112 may be estimated using index marks 166 or by noting the change in the level of contents 154 within container 112 during addition. The added amount of contents 154 may also be metered by valve 160, for example by providing a hollow chamber (not shown in FIG. 1) inside valve 160 holding a specified amount (for example, 0.5 fluid ounce or 14.8 mL) of contents 154 and configuring valve 160 so that the entirety of contents 154 within such chamber are dispensed from spout 164 when the handle on valve 160 is rotated one full turn. Additional turns can be used to dispense additional contents 154. A typical addition of a mixture of synergist or siccative to a 1 gallon (3.78 L) base paint or stain container may for example be about 1 to about 5 fluid ounces (about 30 to 150 mL) of contents 154 and need not be as precisely measured as when adding colorants. Thus for a valve 160 configured as described above, a single turn of the valve handle might be used to dispense sufficient contents 154 into a 1 quart (0.946 L) container holding a solvent-borne paint or stain, and four full turns might be used to dispense sufficient contents 154 into a 1 gallon (3.78 L) container holding such paint or stain. In some embodiments, the tinted paint or stain may include about 1 to about 4 fl oz/gal synergist and about 0.01 to about 0.25 fl oz/gal siccative.

When tinting a water-borne base paint or stain such as base paint or stain 104, a synergist and siccative preferably are not employed. When tinting a solvent-borne base paint or stain such as base paint or stain 114, a synergist (and in many instances also a siccative) are usually employed together with one or more colorants, and may be omitted only when the volume or type of colorant is such that compatibility problems will not be expected to arise. By way of example, canister 138d includes a metered dispensing cylinder 140d containing a piston and connecting link (neither of which is shown in FIG. 1) joined to movable handle 142d whose position can be adjusted vertically along cylinder 140d to provide for the metered delivery of colorant, synergist or siccative from canister 138d through dispensing outlet 144d and into a container such as base paint or stain container 102 or 112 placed on shelf 134. The remaining canisters include similar but unnumbered metered dispensing cylinders, pistons, connecting links, handles and dispensing outlets. Release lever 150 permits turntable 136 to be rotated as needed to bring each colorant, synergist or siccative canister in line above shelf 134 and locked into place while colorant, synergist or siccative is metered and dispensed into a base paint or stain container. The amount and type of synergist and siccative that will be dispensed into a solvent-borne base paint or stain may in the interest of simplicity be the same whenever a solvent-borne base paint or stain is tinted. In other embodiments, the amount or type of synergist(s) or siccative(s) may be varied depending on the amount of colorant to be added (viz., a particular siccative may be employed when a dark or deep tint is prepared and another siccative may be employed when a light pastel tint is prepared), the type of colorant to be added (viz., more synergist or another synergist may be employed when a green or blue tint is prepared, and less or no synergist may be employed when a black or yellow tint is prepared), or both the amount and type of colorant to be added. The amount or type of synergist(s) and siccative(s) may also be varied depending upon the chosen solvent-borne base paint or stain. Preferably synergist(s) and siccative(s) are added prior to the addition of colorants, but this is not required.

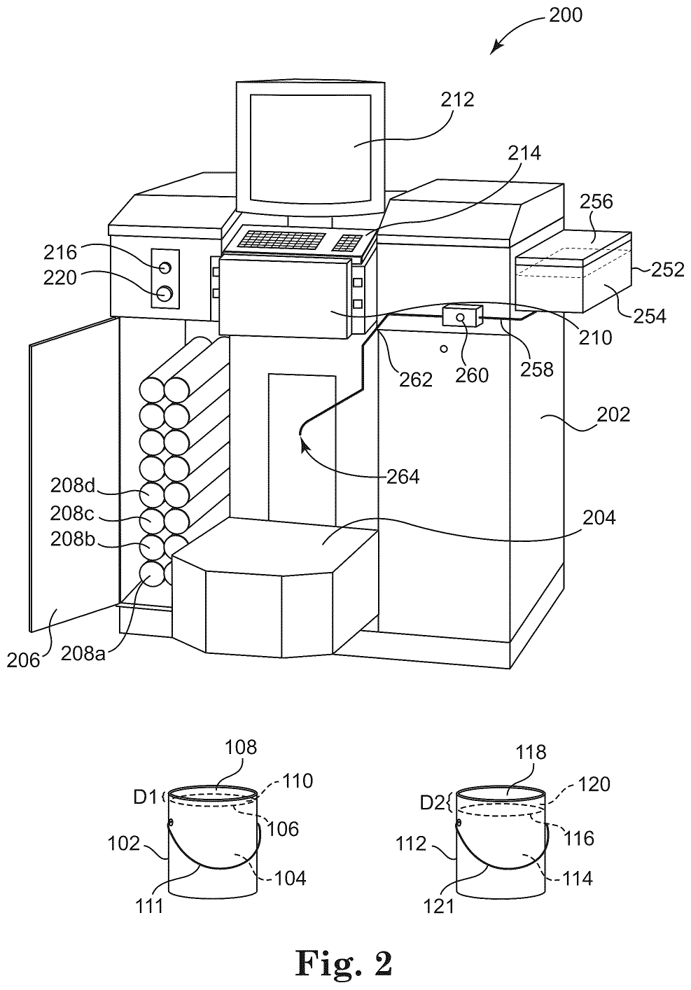

FIG. 2 shows a perspective view of an embodiment 200 of the disclosed paint and stain mixing system. Base paint or stain containers 102 and 112 are as in FIG. 1. Containers 102 and 112 may be combined with one or more colorants using, for example, automated colorant dispenser 202. Dispenser 202 includes a shelf 204 where containers 102 or 112 may be placed for colorant addition and if desired the addition of other ingredients such as a synergist, siccative, or combinations thereof. Cabinet 206 holds a series of replaceable dispenser canisters (sixteen in this case, four of which are numbered as 208a, 208b, 208c and 208d) containing a point-of-sale array of liquid colorants in most or all of the canisters and optionally containing synergist, siccative, or synergist and siccative combined together as a mixture in one or more remaining canisters. Colorant, synergist, siccative or a mixture of synergist and siccative may be dispensed from the appropriate canister through suitable internal plumbing in cabinet 206 (not shown in FIG. 2) and suitable dispensing nozzles (not shown in FIG. 2) positioned in dispensing head 210, and thence into a base paint or stain container. In some embodiments, synergist, siccative or mixture thereof may be dispensed into solvent-borne base paint or stain 114 from a separate bolt-on dispenser. An exemplary such separate dispenser is represented by reservoir 252 which contains contents 254 (shown in phantom view) representing a synergist, siccative or mixture thereof. Reservoir 252 may include removable cover 256 or other suitable closure to permit refilling of reservoir 252. Outlet conduit 258, electrically-operated metering valve 260 and dispensing spout 262 may be used to dispense contents 254 into container 122 from spout outlet 264. A microprocessor or other control device (not shown in FIG. 2) may be used to meter the amount of contents 254 added to container 112. A monitor 212 and keyboard 214 permit information and commands to be entered into dispenser 202. A barcode reader (not shown in FIG. 2) may be used to read information from paint or stain sample cards or base paint or stain containers to assist in controlling the system. A power button 216 and emergency off button 220 may be used to start and stop dispenser 202 and valve 260. As is the case for the embodiments shown in FIG. 1, the amount or type of synergist(s) and siccative(s) may be varied depending on the amount or type of colorant to be added. In addition, and as is the case for the embodiments shown in FIG. 1, the amount or type of synergist(s) and siccative(s) may also be varied depending upon the chosen solvent-borne base paint or stain. Such variations in the amount or type of synergist(s) and siccative(s) will generally be much more easily and reliably accomplished in an automated colorant dispenser like that shown in FIG. 2 than in a manual colorant dispenser like that shown in FIG. 1.

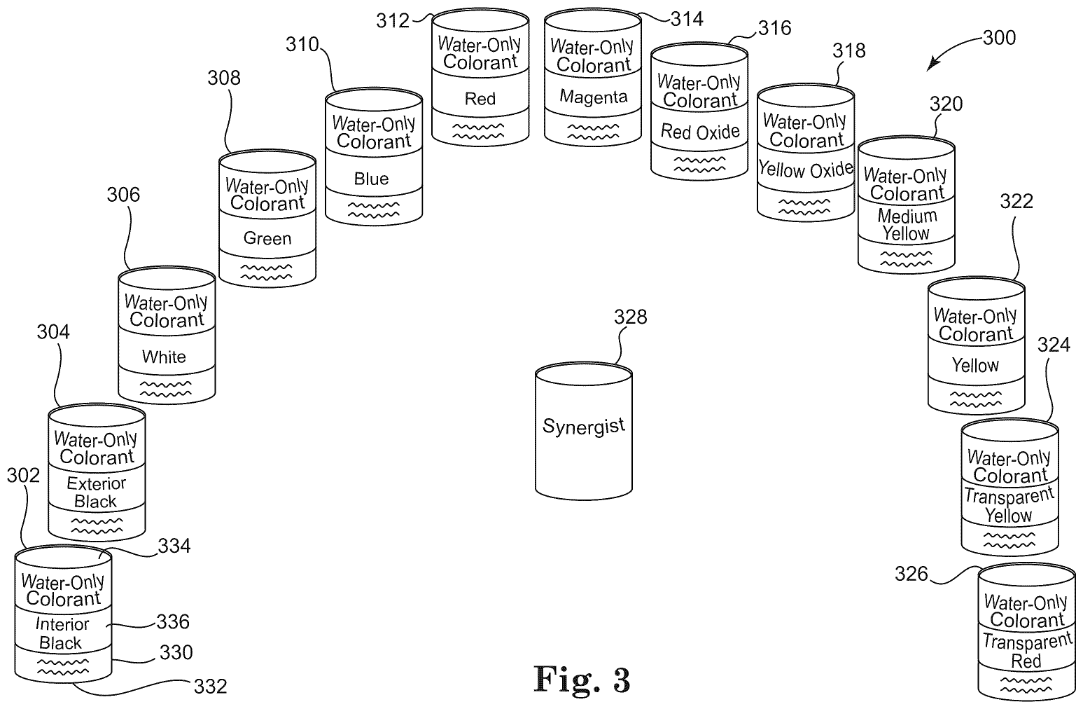

FIG. 3 is a perspective view of a point-of-sale colorant array 300 with thirteen containers 302 through 326 containing water-only fluid colorants in different hues. In the center of FIG. 3 is a fourteenth container designated 328 and containing a synergist and optionally also containing a siccative. In some embodiments, a siccative may be provided in one of containers 302 through 326 and synergist may be provided in container 328 or vice versa. Although not shown in FIG. 3, the corresponding point-of-sale custom color system desirably will also include one or more water-borne paint or stain bases like base 102 in FIG. 1 and FIG. 2, and one or more solvent-borne paint or stain bases like base 112 in FIG. 1 and FIG. 2. Container 302 (which is representative of the other containers in FIG. 3) includes side 330, bottom 332, top 334 and label 336, and may for example contain a water-only liquid colorant such as a carbon black dispersion for use in tinting interior paints. Top 334 preferably is puncturable, shearable or otherwise penetrable, and may resemble the top used in soup cans. Container 304 contains a different water-only liquid colorant such as a dispersion of a non-infrared-absorptive black colorant for use in tinting exterior paints. Containers 306 through 326 preferably contain additional water-only fluid colorants, which in the embodiment shown in FIG. 3 respectively are white, green, blue, red, magenta, red oxide, yellow oxide, medium yellow, yellow, transparent yellow and transparent red colorants. The colorants in containers 302 through 322 include embodiments of the disclosed surfactant package optimized for use of the colorant in water-borne paints and stains, and the colorants in containers 324 and 326 include embodiments of the disclosed surfactant package optimized for use of the colorant in water-borne stains. When added by themselves to a solvent-borne paint or stain, many of the colorants in containers 302 through 326 will exhibit unacceptable compatibility. However, unacceptable compatibility may not be exhibited by all such colorants. For example, the medium yellow colorant in container 320 and the yellow colorant in container 322 may, owing to the nature of these colorants, exhibit acceptable compatibility with both water-borne and solvent-borne paints and stains even in the absence of the synergist in container 328. These latter colorants will nonetheless, in the interest of simplicity, be referred to as “water-only” colorants.

The synergist (and if employed, the optional siccative) in array 300 preferably is optimized to provide improved compatibility, a homogeneous mixture, reduced rub-up and reduced drying times when each of at least colorants 306 through 312, and more preferably when each of colorants 302 through 318 and 324 through 326, is dispensed into a solvent-based paint or stain.

### Test Methods

Rub-up Test: The tinted paints or stains are shaken on a RED-DEVIL cradle type paint shaker for 1 minute, followed by removal of a small aliquot of tinted paint. The remaining sample is shaken an additional 14 minutes, for 15 minutes total. Drawdowns are made using BIRD™ film applicators on white LENETA™ cards to compare the 1-minute and 15-minute shaken samples. An index finger and mild pressure are used to make even circular “rub-up” patterns on the upper outside edge of each coated film, applying shear to the coated areas without rubbing through the film, and normally using at least 5 and up to 25 rubs on each coated film. Rub-ups are rated on a visual None, Trace, Slight, Moderate or Severe scale, with ratings of Moderate or Severe being visibly objectionable.

Colorimeter Test: The above films are allowed to air dry. When dry, a spectrophotometer is used to measure the tinctorial strength and CIELAB delta E color difference between the 1-minute and 15-minute shaken samples, with tinctorial strength ratios from 90% to 110% for the 15-minute vs 1-minute shake times signifying acceptable compatibility, and with ratios from 95% to 105% signifying very acceptable compatibility.

Viscosity Drop Test: ½ pint (8 fluid ounce) samples of water-borne latex paint are tinted at the maximum recommended colorant fill level and shaken on a RED-DEVIL cradle type paint shaker for 1 minute, followed by measurement in Krebs units of the Stromer KU viscosities of the shaken paint samples. Improved performance is shown when the tinted paint viscosity drop is less than that observed using a water-only or universal colorant having the same color.

The disclosed system, method and surfactant package are further described in the following Examples, in which all parts and percentages are by weight unless otherwise indicated.

### Example 1

White, green, blue and red colorants were prepared by mixing the ingredients set out below in Table III.

TABLE III

| | | | | Interior | Exterior |
|---|---|---|---|---|---|
| | White | Green | Blue | Red | Red |
| Ingredient | Colorant | Colorant | Colorant | Colorant | Colorant |
| Linear alcohol ethoxylate | 4.20 | 2.81 | 1.76 | 0.81 | 2.07 |
| (Formula I) | | | | | |
| Tristyryl phenol | 0.88 | 0.96 | 0.87 | 0.79 | 0.97 |
| ethoxylate (Formula II) | | | | | |
| Aliphatic phosphate ester | 0.99 | 1.08 | 0.98 | 0.89 | 2.27 |
| (Formula III) | | | | | |
| Water | 15.57 | 16.84 | 13.43 | 23.00 | 19.76 |
| Humectant | 3.44 | 4.91 | 4.91 | 5.27 | 6.00 |
| pH adjuster | 0.20 | 0.25 | 0.33 | 0.30 | 0.66 |
| Defoamer | 0.32 | 0.43 | 0.38 | 0.72 | 0.20 |
| Preservative | 0.50 | 0.37 | 0.33 | 0.38 | 0.39 |
| Dispersant | | | | 0.64 | 1.64 |
| Thickener | 0.71 | | | 0.14 | |
| Inert Pigment | 6.30 | 13.27 | 11.65 | 12.43 | 2.57 |
| PW 6 TiO₂ | 56.66 | | | | |
| PB 15:2 Phthalocyanine | | | 4.87 | | |
| Blue | | | | | |
| PG 7 Phthalocyanine | | 9.64 | | | |
| Green | | | | | |
| PR 112 Napthol Red | | | | 3.80 | |
| PR 209 Quinacridone Red | | | | 3.60 | |
| PR 254 Pyrrole Red | | | | | 18.82 |
| Extender Paste | 10.23 | 48.68 | 59.25 | 46.85 | 44.66 |
| Shader (added colorant for | | 0.74 | 1.28 | 0.38 | |
| color adjustment) | | | | | |
| | 100.00 | 100.00 | 100.00 | 100.00 | 100.00 |

The colorants all exhibited good compatibility, homogeneity and fluidity.

### Example 2

Using the method of Example 1, yellow, medium yellow, red oxide, yellow oxide, magenta and umber colorants were prepared by mixing the ingredients set out below in Table IV.

TABLE IV

| | | Med | Red | Yellow | | |
|---|---|---|---|---|---|---|
| | Yellow | Yellow | Oxide | Oxide | Magenta | Umber |
| Ingredient | Colorant | Colorant | Colorant | Colorant | Colorant | Colorant |
| Linear alcohol | 7.42 | 7.30 | 3.57 | 3.50 | 3.20 | 0.72 |
| ethoxylate (Form. I) | | | | | | |
| Tristyryl phenol | 0.85 | 0.75 | 1.53 | 1.75 | 3.03 | 2.55 |
| ethoxylate (Form. II) | | | | | | |
| Aliphatic phosphate | 0.96 | 0.84 | 1.43 | 1.25 | 1.01 | 1.43 |
| ester (Formula III) | | | | | | |
| Water | 28.61 | 22.21 | 21.80 | 26.72 | 28.20 | 28.03 |
| Humectant | 5.91 | 5.61 | 3.26 | 4.15 | 6.62 | 5.30 |
| pH adjuster | 0.27 | 0.48 | 0.64 | 0.34 | 0.69 | 0.36 |
| Defoamer | 0.08 | 0.47 | 0.48 | 0.30 | 0.75 | 0.31 |
| Preservative | 0.47 | 0.43 | 0.52 | 0.52 | 0.39 | 0.43 |
| Dispersant | 2.19 | | | 0.90 | | |
| Thickener | 0.25 | | 0.68 | 0.65 | | |
| Inert Pigment | 20.02 | | | | | 7.92 |
| PY74 Monoazo | 14.93 | 11.83 | | | | |
| Yellow | | | | | | |
| PY65 Monoazo | | 24.31 | | | | |
| Yellow | | | | | | |
| PR101 Red Iron | | | 60.60 | | | |
| Oxide | | | | | | |
| PY42 Yellow Iron | | | | 56.44 | | |
| Oxide | | | | | | |
| PR122 Quinacridone | | | | | 13.70 | |
| Red | | | | | | |
| PBr7 Brown Iron | | | | | | 16.55 |
| Oxide | | | | | | |
| PBk7 Carbon Black | | | | | | |
| Extender Paste | 17.40 | 25.77 | 2.99 | 0.97 | 41.74 | 34.17 |
| Shader | 0.65 | | 2.49 | 2.50 | 0.68 | 2.23 |
| | 100.00 | 100.00 | 100.00 | 100.00 | 100.00 | 100.00 |

The colorants all exhibited good compatibility, homogeneity and fluidity.

### Example 3

Using the method of Example 1, an infrared-absorptive black colorant was prepared by mixing the ingredients set out below in the center column of Table V.

TABLE V

| | Black IR | Black Non-IR |
|---|---|---|
| | Absorptive | Absorptive |
| Ingredient | Colorant | Colorant |
| Linear alcohol | 6.26 | 6.26 |
| ethoxylate (Formula I) | | |
| Tristyryl phenol | 3.06 | 3.06 |
| ethoxylate (Formula II) | | |
| Aliphatic phosphate | 1.79 | 1.79 |
| ester (Formula III) | | |
| Water | 22.57 | 22.57 |
| Humectant | 5.43 | 5.43 |
| pH adjuster | 0.48 | 0.48 |
| Defoamer | 0.73 | 0.73 |
| Preservative | 0.41 | 0.41 |
| Inert Pigment | 13.63 | 13.63 |
| PBk7 Carbon Black | 9.54 | |
| PBk32 Perylene Black | | 9.54 |
| Extender Paste | 36.09 | 36.09 |
| | 100.00 | 100.00 |

The Black infrared-absorptive colorant exhibited good compatibility, homogeneity and fluidity. A non-infrared absorptive black colorant with good compatibility, homogeneity and fluidity can be prepared by mixing the ingredients set out in the right-hand column of Table V.

### Example 4

The Example 1, Example 2 and infrared-absorptive Example 3 colorants were added to base paints from McCormick Paints listed below in Table VI, applied as 6 mil (0.15 mm) thick films on unsealed LENETA charts, and evaluated using the Rub-Up and Colorimeter Tests in comparison to NOVOCOLOR II™ universal colorants from Color Corp. of America. The NOVOCOLOR II colorants are described in the above-mentioned U.S. Pat. No. 7,659,350 B2 (Coward et al.).

TABLE VI

| Paint | Base Type |
|---|---|
| TOTAL ADVANTAGE Zero | Flat White Tint Base |
| VOC Interior Latex | |
| TOTAL ADVANTAGE Zero | Eggshell Light Tint Base |
| VOC Interior Latex | |
| TOTAL ADVANTAGE Zero | Eggshell Medium Base |
| VOC Interior Latex | |
| TOTAL ADVANTAGE Zero | Semi-Gloss Light Tint Base |
| VOC Interior Latex | |
| TOTAL ADVANTAGE Zero | Semi-Gloss Medium Tint Base |
| VOC Interior Latex | |
| TOTAL ADVANTAGE Zero | Semi-Gloss Clear (Deep) Tint Base |
| VOC Interior Latex | |
| INTERLOK Int./Ext. Latex | Semi-Gloss White Tint Base |
| Urethane DTM (Direct to Metal) | |
| INTERLOK Int./Ext. Latex | Semi-Gloss Light Tint Base |
| Urethane DTM | |
| INTERLOK Int./Ext. Latex | Semi-Gloss Medium Tint Base |
| Urethane DTM | |
| INTERLOK Int./Ext. Latex | Semi-Gloss Clear (Deep) Tint Base |
| Urethane DTM | |
| REVO LOW VOC Interior Latex | Flat White Tint Base |
| REVO LOW VOC Interior Latex | Flat Light Tint Base |
| REVO LOW VOC Interior Latex | Flat Medium Tint Base |
| REVO LOW VOC Interior Latex | Flat Clear (Deep) Tint Base |
| REVO LOW VOC Interior Latex | Eggshell White Tint Base |
| REVO LOW VOC Interior Latex | Eggshell Light Tint Base |
| REVO LOW VOC Interior Latex | Eggshell Medium Tint Base |
| REVO LOW VOC Interior Latex | Eggshell Clear (Deep) Tint Base |
| REVO LOW VOC Interior Latex | Semi-Gloss White Tint Base |
| REVO LOW VOC Interior Latex | Semi-Gloss Light Tint Base |
| REVO LOW VOC Interior Latex | Semi-Gloss Medium Tint Base |
| REVO LOW VOC Interior Latex | Semi-Gloss Clear (Deep) Tint Base |

The Rub-Up Test results were the same or better in all instances for comparisons of the Example 1, Example 2 and non-infrared-absorbing black colorant from Example 3 to the corresponding NOVOCOLOR II colorants, and were all acceptable. The Colorimeter Test results showed that acceptable compatibility was obtained for all bases using these Example 1, 2 and 3 colorants, and very acceptable compatibility was obtained for all bases using nearly all of the Example 1, 2 and 3 colorants. For instance, use of the Example 1 green colorant in REVO LOW VOC Flat Clear (Deep) Tint Base provided very acceptable compatibility whereas use of the NOVOCOLOR II green colorant did not (e.g., a delta E ratio of 101.83 for the Example 1 green vs. 105.70 for NOVOCOLOR II green). Also, use of the Example 1 blue colorant in TOTAL ADVANTAGE Eggshell Medium Base provided very acceptable compatibility whereas use of the NOVOCOLOR II green colorant did not (e.g., a delta E ratio of 97.35 for the Example 1 blue vs. 140.98 for NOVOCOLOR II blue).

The Viscosity Drop Test results were very favorable. Set out below in Table VII are Viscosity Drop Test results comparing the colored (viz., non-white) colorants from Examples 1, 2 and the non-infrared-absorbing black colorant from Example 3 to the corresponding NOVOCOLOR II colorants when added to three different INTERLOK Int./Ext. Latex Urethane Direct to Metal bases. For all tints, reduced viscosity drop was observed using the Example 1, 2 and 3 colorants. These results are especially important for use in point of sale paint and stain tinting systems, as they enable the user to exercise better brush and edge control across tints and after stirring or other agitation.

TABLE VI

| | Stromer KU Viscosity, Krebs Units | | |
|---|---|---|---|
| | INTERLOK DTM Latex Paint Base | | |
| | Semi-Gloss | Semi-Gloss | Semi-Gloss |
| Colorant | Light | Medium | Clear (Deep) |
| None (Untinted) | 109 | 114 | 108 |
| NOVOCOLOR II 8821 | 103 | 99 | 88 |
| Phthalo Green | | | |
| Example 1 Phthalo Green | 107 | 107 | 101 |
| NOVOCOLOR II 8831 | 102 | 99 | 88 |
| Phthalo Blue | | | |
| Example 1 Phthalo Blue | 106 | 106 | 99 |
| NOVOCOLOR II 8847 | 102 | 99 | 87 |
| Interior Red | | | |
| Example 1 Interior Red | 107 | 110 | 104 |
| NOVOCOLOR II 8851 | 97 | 88 | 71 |
| Exterior Red | | | |
| Example 1 Exterior Red | 106 | 106 | 99 |
| NOVOCOLOR II 8813 | 103 | 104 | 91 |
| Yellow | | | |
| Example 2 Yellow | 104 | 104 | 97 |
| NOVOCOLOR II 8814 | 104 | 103 | 91 |
| Med Yellow | | | |
| Example 2 Med Yellow | 105 | 107 | 100 |
| NOVOCOLOR II 8835 | 99 | 97 | 82 |
| Red Oxide | | | |
| Example 2 Red Oxide | 106 | 109 | 102 |
| NOVOCOLOR II 8878 | 103 | 102 | 90 |
| Yellow Oxide | | | |
| Example 2 Yellow Oxide | 107 | 109 | 103 |
| NOVOCOLOR II 8882 | 102 | 98 | 86 |
| Magenta | | | |
| Example 2 Magenta | 107 | 109 | 103 |
| NOVOCOLOR II 8888 | 104 | 103 | 93 |
| Raw Umber | | | |
| Example 2 Raw Umber | 107 | 107 | 101 |
| NOVOCOLOR II 8892 | 92 | 79 | 65 |
| Black | | | |
| Example 3 Black | 104 | 103 | 95 |

### Example 5

Two oil-based paints (SWP™ Exterior Gloss Oil-Based Paint and PROMAR™ 200 Interior Alkyd Eggshell, both from The Sherwin-Williams Company) and two oil-based stains (Semi-Solid Deck and Siding Stain Neutral Base and Semi-Transparent Stain Neutral Base, both from The Sherwin-Williams Company) were mixed with several colorants from Examples 1 through 3 and evaluated using the Rub-Up and Colorimeter Tests, both with and without addition of a synergist. The synergist was made using 76.68 Wt. % of an isopropyl amine salt of a linear alkylbenzene sulfonic acid, 16.82 wt. % propylene glycol, 2.24 wt. % of a liquid thixotropic additive and 4.26 wt. % iron-based siccative catalyst. The colorants were added to the oil-based paints at 4 oz/gal (31.25 mL/L). The colorants were added to the oil-based stains at 10 oz/gal (78.125 ML/L) along with 2 oz/gal (15.625 mL/L) of the white Example 1 colorant. The synergist was added in the amounts shown below in Table VIII.

TABLE VIII

| | Tint | | |
|---|---|---|---|
| | Strength | | |
| Colorant | Ratio | CIE ΔE | Rub-Up? |
| Example 1 Water-Only Blue | | | |
| SWP Exterior Gloss Oil-Based Paint | 214.00% | 11.48 | Moderate |
| | | | Dark |
| +2.25 oz/gal (17.6 mL/L) Synergist | 100.04% | 0.11 | None |
| PROMAR 200 Interior Alkyd | 165.80% | 7.63 | Trace Dark |
| Eggshell | | | |
| +2.25 oz/gal (17.6 mL/L) Synergist | 97.63% | 0.49 | None |
| Semi-Solid Deck and Siding Stain | 230.80% | 12.23 | Severe Dark |
| Neutral Base | | | |
| +2.25 oz/gal (17.6 mL/L) Synergist | 100.81% | 0.35 | None |
| Semi-Transparent Stain Neutral Base | 153.63% | 7.93 | Severe Dark |
| +2.25 oz/gal (17.6 mL/L) Synergist | 106.61% | 0.29 | None |
| Example 1 Water-Only Interior Red | | | |
| SWP Exterior Gloss Oil-Based Paint | 105.67% | 1.02 | Severe Dark |
| +2.25 oz/gal (17.6 mL/L) Synergist | 103.96% | 0.53 | None |
| PROMAR 200 Interior Alkyd | 125.12% | 4.00 | Mod Dark |
| Eggshell | | | |
| +2.25 oz/gal (17.6 mL/L) Synergist | 99.66% | 0.09 | None |
| Semi-Solid Deck and Siding Stain | 134.34% | 8.32 | Severe Dark |
| Neutral Base | | | |
| +2.25 oz/gal (17.6 mL/L) Synergist | 115.03% | 1.57 | None |
| Semi-Transparent Stain Neutral Base | 122.97% | 5.85 | Severe Dark |
| +2.25 oz/gal (17.6 mL/L) Synergist | 119.29% | 1.85 | Trace Dark |
| Example 2 Water-Only Yellow | | | |
| SWP Exterior Gloss Oil-Based Paint | 134.10% | 4.92 | None |
| +2.25 oz/gal (17.6 mL/L) Synergist | 108.79% | 1.53 | None |
| PROMAR 200 Interior Alkyd | 143.28% | 6.58 | None |
| Eggshell | | | |
| +2.25 oz/gal (17.6 mL/L) Synergist | 102.35% | 0.50 | None |
| Semi-Solid Deck and Siding Stain | 284.47% | 22.93 | Severe Dark |
| Neutral Base | | | |
| +2.25 oz/gal (17.6 mL/L) Synergist | 172.53% | 8.81 | None |
| Semi-Transparent Stain Neutral Base | 154.26% | 10.40 | Severe Dark |
| +2.25 oz/gal (17.6 mL/L) Synergist | 170.13% | 8.10 | None |
| Example 2 Water-Only | | | |
| Medium Yellow | | | |
| SWP Exterior Gloss Oil-Based Paint | 116.70% | 2.91 | Slight Dark |
| +2.25 oz/gal (17.6 mL/L) Synergist | 103.38% | 0.48 | None |
| PROMAR 200 Interior Alkyd | 127.71% | 4.71 | Slight Dark |
| Eggshell | | | |
| +2.25 oz/gal (17.6 mL/L) Synergist | 100.20% | 0.08 | None |
| Semi-Solid Deck and Siding Stain | 524.65% | 29.43 | Slight Dark |
| Neutral Base | | | |
| +2.25 oz/gal (17.6 mL/L) Synergist | 166.34% | 5.94 | None |
| Semi-Transparent Stain Neutral Base | 529.84% | 28.16 | Slight Dark |
| +2.25 oz/gal (17.6 mL/L) Synergist | 174.63% | 6.35 | None |
| Example 2 Water-Only | | | |
| Yellow Oxide | | | |
| SWP Exterior Gloss Oil-Based Paint | 91.98% | 0.39 | None |
| +2.25 oz/gal (17.6 mL/L) Synergist | 104.88% | 0.57 | None |
| PROMAR 200 Interior Alkyd | 111.82% | 0.04 | None |
| Eggshell | | | |
| +2.25 oz/gal (17.6 mL/L) Synergist | 100.07% | 0.04 | None |
| Semi-Solid Deck and Siding Stain | 359.61% | 18.36 | Severe Dark |
| Neutral Base | | | |
| +2.25 oz/gal (17.6 mL/L) Synergist | 157.61% | 5.84 | Trace Dark |
| Semi-Transparent Stain Neutral Base | 240.14% | 13.31 | Severe Dark |
| +2.25 oz/gal (17.6 mL/L) Synergist | 207.65% | 9.36 | Trace Dark |
| Example 2 Water-Only Magenta | | | |
| SWP Exterior Gloss Oil-Based Paint | 149.25% | 8.10 | Moderate |
| | | | Dark |
| +2.25 oz/gal (17.6 mL/L) Synergist | 99.05% | 0.30 | Trace Dark |
| PROMAR 200 Interior Alkyd | 146.28% | 7.86 | Moderate |
| Eggshell | | | Dark |
| +2.25 oz/gal (17.6 mL/L) Synergist | 98.64% | 0.26 | None |
| Semi-Solid Deck and Siding Stain | 97.88% | 6.40 | Severe Dark |
| Neutral Base | | | |
| +2.25 oz/gal (17.6 mL/L) Synergist | 136.60% | 3.65 | None |
| Semi-Transparent Stain Neutral Base | 97.09% | 3.31 | Severe Dark |
| +2.25 oz/gal (17.6 mL/L) Synergist | 135.62% | 2.82 | None |
| Example 2 Water-Only Umber | | | |
| SWP Exterior Gloss Oil-Based Paint | 152.76% | 3.95 | Moderate |
| | | | Dark |
| +2.25 oz/gal (17.6 mL/L) Synergist | 101.64% | 0.17 | None |
| PROMAR 200 Interior Alkyd | 117.88% | 1.61 | Moderate |
| Eggshell | | | Dark |
| +2.25 oz/gal (17.6 mL/L) Synergist | 99.05% | 0.10 | None |
| Semi-Solid Deck and Siding Stain | 152.92% | 5.97 | Severe Dark |
| Neutral Base | | | |
| +2.25 oz/gal (17.6 mL/L) Synergist | 83.62% | 2.44 | Slight Dark |
| Semi-Transparent Stain Neutral Base | 162.95% | 6.57 | Severe Dark |
| +2.25 oz/gal (17.6 mL/L) Synergist | 99.00% | 0.13 | Slight Dark |
| Example 3 Water-Only | | | |
| IR-Absorbent Black | | | |
| SWP Exterior Gloss Oil-Based Paint | 180.32% | 6.44 | Trace Dark |
| +2.25 oz/gal (17.6 mL/L) Synergist | 101.42% | 0.19 | None |
| PROMAR 200 Interior Alkyd | 139.86% | 3.82 | Slight Dark |
| Eggshell | | | |
| +2.25 oz/gal (17.6 mL/L) Synergist | 101.14% | 0.13 | None |
| Semi-Solid Deck and Siding Stain | 325.48% | 13.64 | Severe Dark |
| Neutral Base | | | |
| +2.25 oz/gal (17.6 mL/L) Synergist | 137.14% | 2.01 | Trace Dark |
| Semi-Transparent Stain Neutral Base | 317.28% | 13.25 | Severe Dark |
| +2.25 oz/gal (17.6 mL/L) Synergist | 158.89% | 2.75 | Slight Dark |

The results in Table VIII results show that when the synergist was employed, a significant improvement in Tint Strength stability was obtained in almost every instance, and the Rub-Up performance results were as least as good and often significantly improved compared to use of the colorant without the synergist.

Having thus described preferred embodiments of the present invention, those of skill in the art will readily appreciate that the teachings found herein may be applied to yet other embodiments within the scope of the claims hereto attached. The complete disclosure of all patents, patent documents, and publications are incorporated herein by reference as if individually incorporated.

Embodiment 1: Embodiment of a point-of-sale custom color system for tinting water-borne architectural base paints and stains, the system comprising an array of low volatile organic compound water-only liquid colorants including at least white, green, blue and red colorants each including an at least three-component surfactant package that will compatibly and homogeneously disperse the colorant throughout a water-borne base paint or stain but will not compatibly and homogeneously disperse the colorant throughout a solvent-borne base paint or stain unless the colorant is used in combination with a synergist containing one or more ingredients that will disperse the water-only colorants into solvent-borne base paints or stains; pigment; and a vehicle.

Embodiment 2: Embodiment of a method for point-of-sale custom paint or stain tinting, the method comprising using an automated or manual colorant dispenser to dispense into water-borne base paints or stains at a retail, wholesale or combined retail/wholesale outlet one or more water-only liquid colorants selected from an array of colorants including at least white, green, blue and red colorants each including an at least three-component surfactant package that will compatibly and homogeneously disperse the colorant throughout water-borne base paints and stains but will not compatibly and homogeneously disperse the colorant throughout solvent-borne base paints and stains unless the colorant is used in combination with a synergist containing one or more ingredients that will disperse the water-only colorants into solvent-borne base paints or stains; pigment; and a vehicle.

Embodiment 3: Embodiment of a point-of-sale custom color system for tinting water-borne architectural base paints and stains, the system comprising an array of low volatile organic compound water-only liquid colorants including at least white, green, blue and red colorants each comprising an at least three-component surfactant package that will compatibly and homogeneously disperse the colorant throughout a water-borne base paint or stain and will compatibly and homogeneously disperse the colorant throughout a solvent-borne base paint or stain if the colorant is used in combination with a synergist containing one or more ingredients that will disperse the water-only colorants into solvent-borne base paints or stains; pigment; and a vehicle.

Embodiment 4: Embodiment of a method for point-of-sale custom paint or stain tinting, the method comprising using an automated or manual colorant dispenser to dispense into water-borne base paints or stains at a retail, wholesale or combined retail/wholesale outlet one or more water-only liquid colorants selected from an array of colorants including at least white, green, blue and red colorants each including an at least three-component surfactant package that will compatibly and homogeneously disperse the colorant throughout water-borne base paints and stains and will compatibly and homogeneously disperse the colorant throughout solvent-borne base paints and stains if the colorant is used in combination with a synergist containing one or more ingredients that will disperse the water-only colorants into solvent-borne base paints or stains; pigment; and a vehicle.

Embodiment 5: Embodiment of a method according to 2 or 4, the method further comprising:
dispensing the water-only colorants into the water-borne paints and stains to tint a water-borne paint or stain; or
to tint a solvent-borne base paint or stain,
   a) dispensing one or more water-only colorants as well as a synergist into the solvent-borne base paint or stain, or
   b) dispensing one or more water-only colorants into the solvent-borne base paint or stain containing a synergist.

Embodiment 6: Embodiment of a packaged colorant comprising a low volatile organic compound water-only liquid colorant comprising an at least three-component surfactant package that will compatibly and homogeneously disperse the colorant throughout a water-borne base paint or stain but will not compatibly and homogeneously disperse the colorant throughout a solvent-borne base paint or stain unless the colorant is used in combination with a synergist containing one or more ingredients that will disperse the water-only colorant into a solvent-borne base paint or stain; pigment; and a vehicle, packaged in a container having a volume of about 0.5 to about 5 L.

Embodiment 7: Embodiment of the system, method or packaged colorant according to any preceding embodiment, wherein the colorant is packaged in containers from which colorant is gravimetrically or volumetrically dispensed via an automated or manual colorant dispenser into base paints or stains in containers having a volume of about 0.2 to 20 L.

Embodiment 8: Embodiment of the system, method or packaged colorant according to any preceding embodiment, further comprising at least one water-borne base paint or stain and at least one solvent-borne base paint or stain, the base paints or stains being packaged in largely but incompletely filled point-of-sale containers with a volume of about 0.2 to 20 L equipped with an openable and recloseable lid, cap or other closure for an opening through which colorant may be dispensed from an automated or manual colorant dispenser into a base paint or stain.

Embodiment 9: Embodiment of the system, method or packaged colorant according to any preceding embodiment, further comprising red, yellow and black colorants.

Embodiment 10: Embodiment of the system, method or packaged colorant according to any preceding embodiment, further comprising medium yellow, red oxide, yellow oxide, magenta and umber colorants.

Embodiment 11: Embodiment of the system, method or packaged colorant according to any preceding embodiment, wherein the surfactant package comprises at least two nonionic surfactants and at least one anionic surfactant.

Embodiment 12: Embodiment of the system, method or packaged colorant according to embodiment 11, wherein the nonionic surfactants include a hydrophilic alkylene oxide portion and a hydrophobic portion, with the hydrophobic portion of at least one of the nonionic surfactants containing a linear or branched chain aliphatic group, and the hydrophobic portion of at least another of the nonionic surfactants containing one or more aromatic rings.

Embodiment 13: Embodiment of the system, method or packaged colorant according to embodiment 12, wherein the nonionic surfactant hydrophilic alkylene oxide portion contains a plurality of —CH₂CH₂O— groups.

Embodiment 14: Embodiment of the system, method or packaged colorant according to embodiment 12 or embodiment 13, wherein the linear or branched chain aliphatic group comprises an alkyl group or mixture of alkyl groups having 1-20 carbons.

Embodiment 15: Embodiment of the system, method or packaged colorant according to any one of embodiments 12 to 14, wherein the aromatic rings are 1, 2, 3 or 4 six-carbon aromatic rings.

Embodiment 16: Embodiment of the system, method or packaged colorant according to any one of embodiments 11 to 15 wherein the at least one anionic surfactant includes a hydrophilic alkylene oxide portion and a hydrophobic portion including a phosphorus group or a sulfur group.

Embodiment 17: Embodiment of the system, method or packaged colorant according to embodiment 16, wherein the anionic surfactant hydrophilic alkylene oxide portion includes a plurality of —CH₂CH₂O— groups.

Embodiment 18: Embodiment of the system, method or packaged colorant according to embodiment 16 or embodiment 17, wherein the anionic surfactant hydrophobic portion includes a phosphate ester group.

Embodiment 19: Embodiment of the system, method or packaged colorant according to embodiment 16 or embodiment 17, wherein the anionic surfactant hydrophobic portion includes a sulfate or sulfonate group.

Embodiment 20: Embodiment of the system, method or packaged colorant according to any preceding embodiments, wherein the surfactants in the surfactant package each have a number average molecular weight less than 2,000 g/mol.

Embodiment 21: Embodiment of the system or method according to any preceding embodiment, wherein the colorants in the array each contain at least about 0.5 and up to about 20 wt. % of the surfactant package.

Embodiment 22: Embodiment of the system or method according to any preceding embodiment, wherein different colorants in the array contain different overall amounts of the surfactant package.

Embodiments 23: Embodiment of the system or method according to any preceding embodiment, wherein different colorants in the array contain different amounts or different relative ratios of each surfactant.

Embodiment 24: Embodiment of the system or method according to any preceding embodiment, wherein the array contains yellow and black colorants that contain a greater amount of the surfactant package relative to other colorants.

Embodiment 25: Embodiment of the system, method or packaged colorant according to any preceding embodiment, wherein the colorant(s) contain at least about 2 and up to about 90 wt. % pigment.

Embodiment 26: Embodiment of the system, method or packaged colorant according to any preceding embodiment, wherein the colorant(s) contain at least about 0.5 and up to about 80 wt. % combined weight of pigment, extender, inert pigment and filler.

Embodiment 27: Embodiment of the system, method or packaged colorant according to any preceding embodiment, wherein one or more colorants contain at least about 0.1 and up to about 5 wt. % pigment dispersing agent.

Embodiment 28: Embodiment of the system or method according to any preceding embodiment, wherein all the colorants in the array are water-only colorants.

Embodiment 29: Embodiment of the system or method according to any preceding embodiment, further comprising the synergist.

Embodiment 30: Embodiment of the system or method according to any preceding embodiment, further comprising a siccative.

Embodiment 31: Embodiment of an at least three-component surfactant package for use in making water-only liquid colorants for tinting water-borne base paints and stains, the package comprising a mixture of surfactants having Formulas I, II and III below:

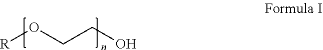

where R is a linear or branched chain alkyl group or mixture of groups having 1-20 carbons, and n is the number of moles of ethylene oxide and is at least 7 and up to 50;

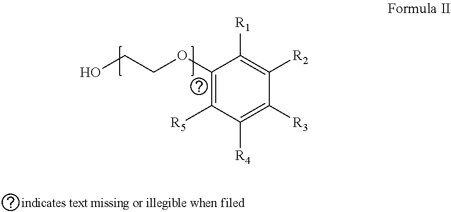

where m is the number of moles of ethylene oxide and is at least 5 and up to 25, and in some embodiments is at least 10 and up to 20; and R₁, R₂, R₃, R₄ and R₅ are independently hydrogen or linear or branched aliphatic or aromatic hydrocarbon groups containing at least 4 and up to 10 carbon atoms; and

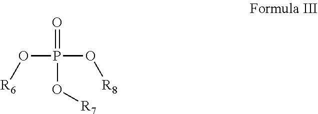

where R₆ is hydrogen or an ethylene oxide chain containing at least 5 and up to 15 moles and a terminal hydrogen atom, nitrogen group, alkyl group or alkaryl group, and R₇ and R₈ are independently hydrogen, sodium, potassium, a counter ion, or an ethylene oxide chain containing at least 5 and up to 15 moles EO and a terminal hydrogen atom, alkyl group or alkaryl group.

Embodiment 32: Embodiment of a surfactant package according to embodiment 29, comprising a mixture of:
a) alcohol ethoxylate having a hydrophile-lipophile balance (HLB value) of 12 to 20;
b) tristyryl phenol ethoxylate with 5 to 15 moles ethylene oxide; and
c) aliphatic phosphate ester with 5 to 15 moles ethylene oxide.

1. A water-only liquid colorant comprising an at least three-component surfactant package, wherein the surfactant package comprises at least two nonionic surfactants and at least one anionic surfactant, and wherein the nonionic surfactants include a hydrophilic alkylene oxide portion and a hydrophobic portion, with the hydrophobic portion of at least one of the nonionic surfactants containing a linear or branched chain aliphatic group, and the hydrophobic portion of at least another of the nonionic surfactants containing one or more aromatic rings, wherein the liquid colorant is suitable to disperse into a water-based base paint or stain without a synergist; and wherein the liquid colorant is not suitable to disperse into a solvent-borne base paint or stain without a synergist.

2. The liquid colorant according to claim 1, wherein the nonionic surfactant hydrophilic alkylene oxide portion contains a plurality of —CH₂CH₂O— groups.

3. The liquid colorant according to claim 1, wherein the linear or branched chain aliphatic group includes an alkyl group.

4. The liquid colorant according to claim 1, wherein each nonionic surfactant includes a linear or branched chain alkyl group or a mixture of alkyl groups having 1-20 carbons.

5. The liquid colorant according to claim 1, wherein the aromatic rings each have 1, 2, 3 or 4 carbon atoms.

6. The liquid colorant according to claim 1, wherein the at least one anionic surfactant includes a hydrophilic alkylene oxide portion and a hydrophobic portion including a phosphorus group or a sulfur group.

7. The liquid colorant according to claim 6, wherein the anionic surfactant hydrophilic alkylene oxide portion includes a plurality of —CH₂CH₂O— groups.

8. The liquid colorant according to claim 7, wherein the anionic surfactant hydrophobic portion includes a phosphate ester group.

9. The liquid colorant according to claim 6, wherein the anionic surfactant hydrophobic portion includes a sulfate or sulfonate group.

10. The liquid colorant according to claim 1, wherein the surfactants in the surfactant package each have a number average molecular weight less than 2,000 g/mol.

11. The liquid colorant of claim 1, wherein the colorant contains at least about 0.5 and up to about 20 wt. % of the surfactant package.

12. The liquid colorant according to claim 1, wherein the colorant further comprises at least about 2 and up to about 90 weight percent of one or more pigments.

13. The liquid colorant according to claim 1, wherein the colorant contains at least about 0.5 weight percent and at most about 80 weight percent combined weight of pigment, extender, inert pigment and filler.

14. The liquid colorant of claim 1, wherein one or more colorants contain at least about 0.1 weight percent and at most about 5 weight percent pigment dispersing agent.

15. A liquid package for use in making water-only liquid colorants for tinting water-borne base paints and stains, the package comprising a mixture of surfactants having Formulas I, II and III below: 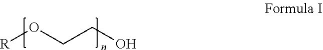
where R is a linear or branched chain alkyl group or mixture of groups having 1-20 carbons, and n is the number of moles of ethylene oxide and is at least 7 and up to 50; 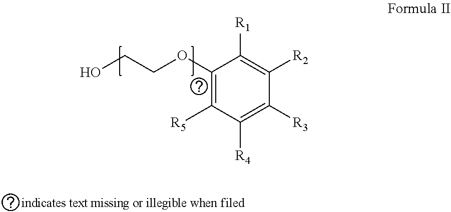
where m is the number of moles of ethylene oxide and is at least 5 and up to 25, and in some embodiments is at least 10 and up to 20; and R₁, R₂, R₃, R₄ and R₅ are independently hydrogen or linear or branched aliphatic or aromatic hydrocarbon groups containing at least 4 and up to 10 carbon atoms; and 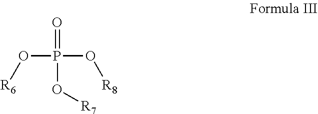
where R₆ is hydrogen or an ethylene oxide chain containing at least 5 and up to 15 moles and a terminal hydrogen atom, nitrogen group, alkyl group or alkaryl group, and R₇ and R₈ are independently hydrogen, sodium, potassium, a counter ion, or an ethylene oxide chain containing at least 5 and up to 15 moles EO and a terminal hydrogen atom, alkyl group or alkaryl group.

16. The liquid package according to claim 15, wherein the package contains:
d) alcohol ethoxylate having a hydrophile-lipophile balance (HLB value) of 12 to 20;
e) tristyryl phenol ethoxylate with 5 to 15 moles ethylene oxide; and
f) aliphatic phosphate ester with 5 to 15 moles ethylene oxide.

17. A packaged colorant comprising a low volatile organic compound water-only liquid colorant comprising an at least three-component surfactant package that will compatibly and homogeneously disperse the colorant throughout a water-borne base paint or stain but will not compatibly and homogeneously disperse the colorant throughout a solvent-borne base paint or stain unless the colorant is used in combination with a synergist containing one or more ingredients that will disperse the water-only colorant into a solvent-borne base paint or stain; pigment; and a vehicle, the colorant packaged in a container having a volume of about 0.5 to about 5 L.

18. The packaged colorant of claim 17, wherein the base paints or stains are packaged in partially-filled point-of-sale containers with a volume of about 0.2 to 20 L equipped with an openable and recloseable closure for an opening through which colorant may be dispensed from an automated or manual colorant dispenser into a base paint or stain.
